(19) United States
(12) Patent Application Publication
(10) Pub. No.: US 2012/0161526 A1
(43) Pub. Date: Jun. 28, 2012

(54) DC POWER SOURCE CONVERSION MODULES, POWER HARVESTING SYSTEMS, JUNCTION BOXES AND METHODS FOR DC POWER SOURCE CONVERSION MODULES

(75) Inventors: Gui-Song HUANG, Taoyuan Hsien (TW); Peng QU, Taoyuan Hsien (TW); Jie HUANG, Taoyuan Hsien (TW)

(73) Assignee: DELTA ELECTRONICS, INC., Taoyuan Hsien (TW)

(21) Appl. No.: 13/338,044

(22) Filed: Dec. 27, 2011

(30) Foreign Application Priority Data
Dec. 28, 2010 (CN) 201010623132.1

(51) Int. Cl. H02J 1/00; G05F 3/08

(52) U.S. Cl. 307/77; 323/304

(57) ABSTRACT

A DC power source conversion module is provided, including a DC power source module and a DC to DC conversion module. The DC to DC conversion module includes a DC to DC converter and a control module. The DC to DC converter is powered by the DC power source module to generate an output signal. The control module senses a responding signal of the DC to DC conversion module and controls the DC to DC converter according to the sensed responding signal, such that the DC power source conversion module is operated at a predetermined output power, in which the responding signal responds to the output signal of the DC to DC converter.

### CROSS REFERENCE TO RELATED APPLICATIONS

This Application claims priority of China Patent Application No. 201010623132.1, filed on Dec. 28, 2010, the entirety of which is incorporated by reference herein.

### BACKGROUND OF THE INVENTION

1. Field of the Invention

The present invention relates to power generation systems of a distributed power source, and in particular relates to a system and control method for a photovoltaic conversion module.

2. Description of the Related Art

Recently, renewable energy is more and more popular such that research on distributed power sources (e.g., photo-voltaic (PV) cells, fuel cells, vehicle batteries, etc) has increased. Considering some factors (e.g., needs for voltage/current, operation consideration, reliability, security, cost, etc), many topology structures have been proposed for the connection of the loading and the distributed power source. The distributed DC power source mostly provides low voltage output. In general, a cell only provides a few volts, and a module, composed of many cells in a series, can provided tens of volts. Therefore, there is a need for the cells to connect in series to form a module, thereby obtaining required operating voltages. However, a module (i.e., in general, a row of cells composed of 60 cells in series) can not provide required currents, thus, there is a need to connect several cells in parallel for the providing of required current.

Furthermore, the power, generated by each distributed power source, is varied according to process conditions, operation conditions and environmental conditions. For example, due to different process conditions, two of the same power sources have different output properties. Similarly, two of the same power sources have different responses (effects) due to different operation conditions and/or environmental conditions (e.g., loading, temperature, etc). In a real apparatus, different power sources are operated in different environmental conditions. For example, in a photo-voltaic apparatus, a portion of photo-voltaic panels is exposed to the sun, but another portion of the voltaic panels is hidden, thereby different output powers are generated. In an apparatus having multiple cells, the cells have a different degree of aging, such that the cells generate different output powers.

FIG. 1 illustrates the characteristic curve indicating current and power relative to voltage in the photovoltaic (PV) cell. For each photovoltaic cell, the output current is decreased as the output voltage is increased. The output power of the photovoltaic cell is identical to the product of the output voltage and the output current (i.e., P=I×V), and is varied according to the output voltage received by the photovoltaic cell. The photovoltaic cell has different output currents and output voltages in different irradiating conditions. At a certain output voltage, the output power exceeds a maximum power point (i.e., the maximum value of the power to voltage characteristic curve). It would be best that the photovoltaic cell is operated at the maximum power point MPP. The maximum power point tracking (MPPT) finds out the maximum power point and enables the system to operate at the maximum power point MPP, thereby obtaining the maximum output power from the photovoltaic cell. However, in real situations, it is hard to enable the system to be operated with the maximum power point MPP.

FIG. 2 illustrates the maximum power point tracking MPPT principle of a power harvesting system 200 of the prior art. As shown in FIG. 2, the photovoltaic panel (composed of photovoltaic modules) 210 connects to a DC to DC converter 220 by a positive output terminal 211 and a negative output terminal 212. The DC to DC converter 220 provides power/energy to a loading 230. In the power harvesting system 200, a voltage sensor 222 coupled to the positive output terminal 211 samples the input voltage of the DC to DC converter 220 (i.e., output voltage of the photovoltaic panel 210), and the current sensor 223 coupled to the negative output terminal 212 samples the input current of the DC to DC converter 220 (i.e., output current of the photovoltaic panel 210). The multiplier 224 products the input current signal sensed by the current sensor 223 and the input voltage signal sensed by the voltage sensor 222 to generate a power signal. The maximum power point tracking controller 221 enables the power harvesting system 200 to be operated with the maximum power point.

FIG. 3 illustrates a junction box of the prior art, in which the junction box 330 is coupled to a photovoltaic module 320. For example, the photovoltaic module 320 can be at least one photovoltaic cell, or can be a portion of the photovoltaic panel (e.g., photovoltaic panel 210), but is not limited thereto. As shown in FIG. 3, the photovoltaic sub-module 310, also referred to as a PV sub-string, is composed of several photovoltaic cells (e.g., 18 to 20 photovoltaic cells), wherein the photovoltaic cells is connected in series to form a row. The photovoltaic sub-modules 310, 311 and 312 are connected in series to form the photovoltaic module 320. The photovoltaic module 320 is coupled to the junction box 330 having at least one of the bypass diodes 331-333, wherein the photovoltaic sub-modules (photovoltaic series) 310, 311 and 312 are coupled to the bypass diodes 331-333. The bypass diodes 331-333 protect the photovoltaic module 320 from over current or over voltage.

FIG. 4 illustrates a centralized power harvesting system of the prior art, in which the centralized power harvesting system has the maximum power point tracking As shown in FIG. 4, since the voltage provided from each photovoltaic module 410 is very low, there is a need to connect the photovoltaic modules 410 in series into a module string 420. When a large-scale equipment needs a larger current, the large-scale equipment enables several module strings 420 to connect in parallel, thereby forming a front stage (i.e., power stage or photovoltaic panel) of the centralized power harvesting system 400. The photovoltaic module 410 can be disposed outdoors and connected to the maximum power point tracking (MPPT) module 430, and then connected to the DC to AC converter 440. In general, the maximum power point tracking module 430 can be integrated into a portion of the DC to AC converter 440. The DC to AC converter 440 receives the energy (power) received by the photovoltaic module 410, and converts the fluctuating DC voltage to the AC voltage having required voltage and required frequency. For example, the AC voltage can be 110V or 220V with 60 Hz, or 220V with 50 Hz. Note that there are many converters to generate 220V AC voltage in the U.S., but 220V AC voltage is separated into two 110V AC voltages before being fed to the electric box. The AC current generated by the DC to AC converter 440 can be used for the operation of electrical products or fed into the power network. When the centralized power harvesting system 400 is not connected to the power network, the power generated by the DC to AC converter 440 can be delivered to a conversion and charge/discharge circuit to store the redundant electric power/energy in the battery. In the battery-based application, the DC to AC converter 440 can be omitted and the DC energy output from the maximum power point tracking module 430 is directly fed into the conversion and charge/discharge circuit.

As described above, the photovoltaic module 410 only provides very small voltage and current. Thus, a problem to solve faced by a designer of photovoltaic cell arrays (or photovoltaic panel) is, how to combine small voltages and currents, provided by the photovoltaic module 410, by the standard 110V or 220V AC rms output. In general, when the input voltage of a DC to AC converter (e.g., 440) is slightly higher than \sqrt{2} times of root mean square (rms) voltage output from the DC to AC converter (e.g., 440), the DC to AC converter has the best efficiency. Therefore, in some applications, many DC sources (e.g., the photovoltaic module 410) are combined to obtain required voltages or currents. The common way to accomplish the best efficiency is to connect many DC sources in series to obtain required voltages, or to connect many DC sources in parallel to obtain required currents. As shown in FIG. 4, several photovoltaic modules 410 are connected in series to serve as a module string 420, and multiple module strings 420 are connected in parallel with the DC to AC converter 440. Several photovoltaic modules 410 are connected in series to obtain the minimum required voltage of the DC to AC converter 440. Several module strings 420 are connected in parallel to provide a larger current, thereby providing higher output power. Similarly, a junction box having a bypass diode is added in each photovoltaic module 410 for protection, but the junction box is not shown in FIG. 4.

The advantage of this architecture is a low cost and simple structure, but the architecture still has many shortcomings. One of the shortcomings is that every photovoltaic module 410 can not be operated in the best power mode, such that the efficiency of the architecture is not good. It will be illustrated in the following. As described above, the output of the photovoltaic module 410 is affected by many conditions. In order to obtain the maximum power from each photovoltaic module 410, the combination of the obtained voltage and current should vary according to the conditions.

In general, the better way to accomplish required currents or voltage is to connect the DC sources (in particular to an apparatus of photovoltaic modules) are in series. As shown in FIG. 5, each photovoltaic module 510 is coupled to a DC to DC converter 520 having maximum power point tracking though a junction box (not shown in FIG. 5) having bypass diodes, and the outputs of the DC to DC converters 520 are connected in series. The DC to DC converter 520 senses the output voltage and the output current (i.e., the input voltage and the input current of the DC to DC converter 520) of the photovoltaic module 510 to enable the photovoltaic module 510 be operated with the maximum power point. However, all of the output currents of the DC to DC converter 520 must be the same when the DC sources are connected in series, thus, problems will occur when the DC sources are connected in series, even though each photovoltaic module 510 has the maximum power point tracking Because each photovoltaic module 510 is composed of several photovoltaic sub-modules (photovoltaic strings) connected in series (as shown in FIG. 3), The DC to DC converter 520 having the maximum power point tracking can not effectively enable all of the photovoltaic sub-modules (photovoltaic strings) in the photovoltaic module 510 to be operated with the maximum power point. Furthermore, each photovoltaic module 510 coupled to the DC to DC converter 520 having the maximum power point tracking and the DC to DC converter 520 having the maximum power point tracking has a multiplier such that the cost is higher. In addition, each photovoltaic module 510 is coupled to the DC to DC converter 520 having the maximum power point tracking, and the DC to DC converter 520 senses the output voltage and the output current of the photovoltaic module 510 such that the maximum power point tracking is performed according the power generated by the product of the output voltage and the output current, but the rate of the maximum power point tracking is too slow. Therefore, there is a need for a system to connect many DC sources to loadings, for example, a power network, power storage bank, etc.

### BRIEF SUMMARY OF THE INVENTION

In light of the previously described problems, the invention provides an embodiment of a DC power source conversion module, including: a DC power source module and a DC to DC conversion module. The DC to DC conversion module, including: a DC to DC converter and a control module. The DC to DC converter is powered by the DC power source module to generate an output signal. The control module senses a responding signal of the DC to DC conversion module and controls the DC to DC converter according to the sensed responding signal, such that the DC power source conversion module is operated at a predetermined output power, wherein the responding signal responds to the output signal of the DC to DC converter.

The invention also provides a method for a DC power source conversion module. The method comprises the steps of comprising: generating a perturb signal to perturb a control loop of a DC power source converter; performing a positive sampling and a negative sampling on signals responding to an output voltage or an output current in the DC power source conversion module to generate a first sampling signal and a second sampling signal; generating an error amplifier signal according the first sampling signal and the second sampling signal; adding the error amplifier signal with the perturb signal to generate a control signal; and controlling a work frequency or duty cycle of a DC to DC converter in the DC power source conversion module according to the control signal, such that the DC to DC converter is operated with a maximum output power.

The invention provides an embodiment of a power harvesting system, including: a photovoltaic module and a junction box. The photovoltaic module including a plurality of photovoltaic sub-modules, in which each photovoltaic sub-module is composed of a plurality of photovoltaic cells connected in series. The junction box includes a plurality of DC to DC conversion modules connected in series, in which each the DC to DC conversion module includes a DC to DC converter and a control module. The DC to DC converter is powered by one of the photovoltaic sub-modules to generate an output voltage. The control module senses the output voltage and controlling the DC to DC converter according to the sensed output voltage, such that the DC to DC converter is operated in a predetermined power.

The invention provides an embodiment of a power harvesting system, including: a plurality of DC power source conversion module strings and a DC to AC conversion module. The DC power source conversion module strings have output terminals connected in series to provide a first output voltage and a output current, in which each the DC power source conversion module string includes a plurality of photovoltaic conversion modules connected in series and each photovoltaic conversion module includes: a photovoltaic module and a first DC to DC conversion module. The photovoltaic module is composed of a plurality of photovoltaic sub-modules connected in series. The first DC to DC conversion module includes a DC to DC converter and a control module. The DC to DC converter is powered by the photovoltaic module to generate a second output voltage. The control module senses the second output voltage and controlling the DC to DC converter according the sensed second output voltage, such that the DC to DC converter is operated in a first predetermined output power. The DC to AC conversion module is coupled to the DC power source conversion module strings to generate a AC voltage.

The invention provides an embodiment of A junction box, including: at least one DC to DC conversion module and a control module. The DC to DC conversion module includes a DC to DC converter, powered by a DC power source module to generate an output signal. The control module senses a responding signal of the DC to DC conversion module and controls the DC to DC converter according to the sensed responding signal, such that the DC to DC conversion module is operated in a predetermined power, wherein the responding signal responds to the output signal of the DC to DC converter.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 illustrates the characteristic curve indicating current and power relative to voltage in the photovoltaic (PV) cell;

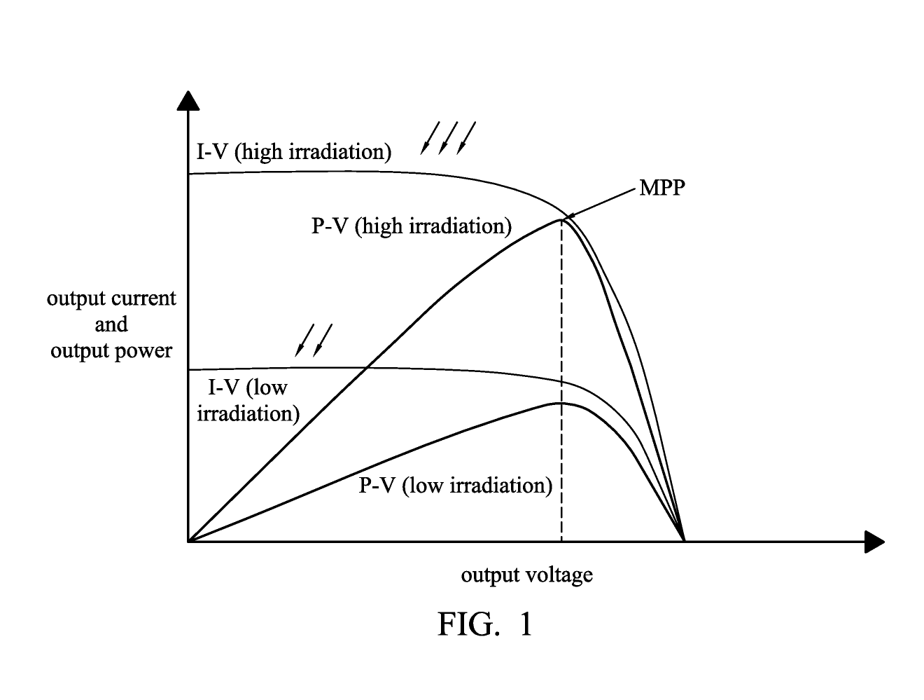

FIG. 2 illustrates the relative art of the maximum power point tracking MPPT principle of a power harvesting system 200;

FIG. 3 illustrates a relative art of a junction box, in which the junction box 330 is coupled to a photovoltaic module 320;

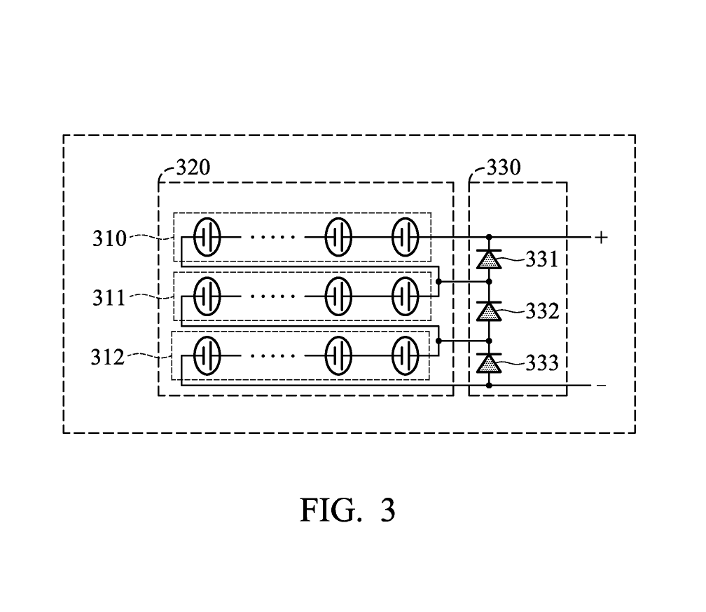

FIG. 4 illustrates a relative art of the centralized power harvesting system having the maximum power point tracking;

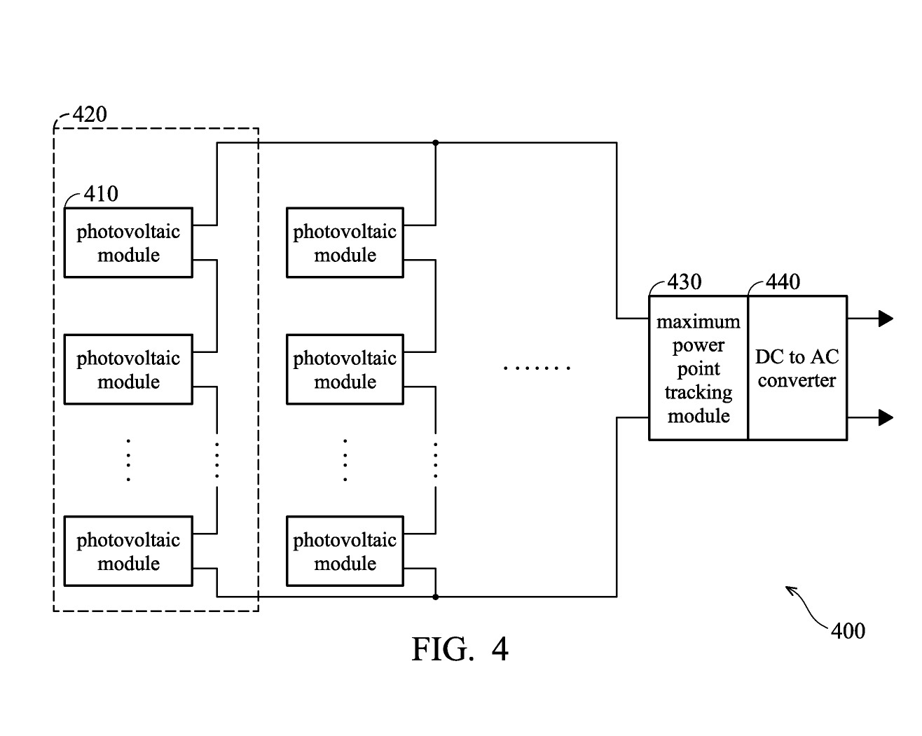

FIG. 5 illustrates a power harvesting system.

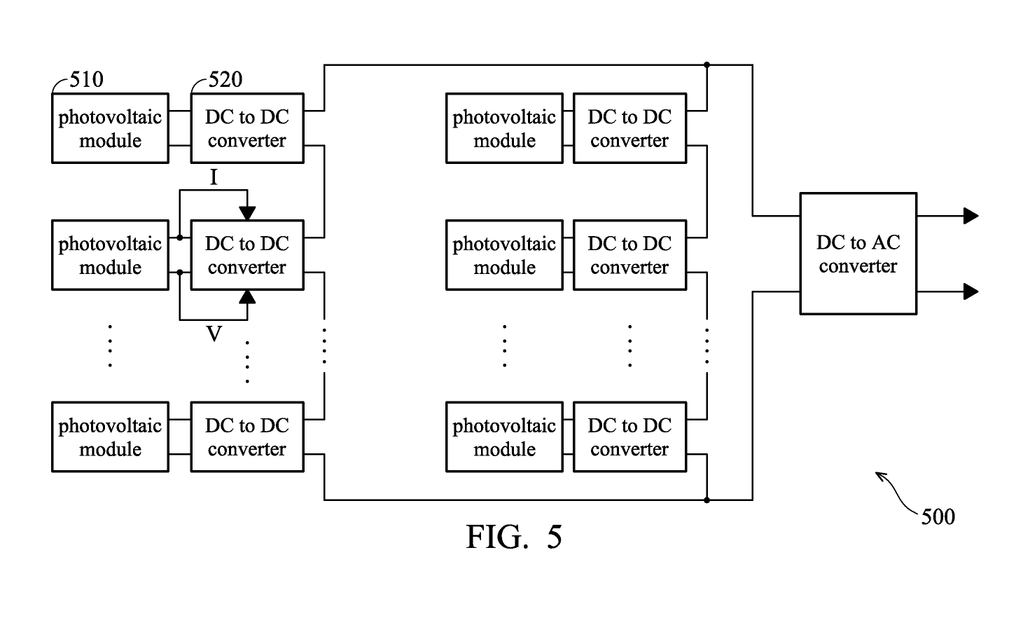

FIG. 6A illustrates an embodiment of a distributed DC power source conversion module of the invention;

FIG. 6B illustrates another embodiment of a distributed DC power source conversion module of the invention;

FIG. 7A illustrates another embodiment of a distributed DC power source conversion module of the invention;

FIG. 7B illustrates the characteristic curve indicating the output current and the output power relative to the output voltage in the distributed DC power source conversion module 700;

FIG. 8A illustrates another embodiment of a distributed DC power source conversion module of the invention;

FIG. 8B illustrates the characteristic curve indicating the output current and the output power relative to the output voltage VOUT in the distributed DC power source conversion module 800;

FIG. 9A illustrates another embodiment of a distributed DC power source conversion module of the invention;

FIG. 9B illustrates the characteristic curve indicating the output current and the output power relative to the output voltage VOUT in the distributed DC power source conversion module 900;

FIG. 9C illustrates another embodiment of a distributed DC power source conversion module of the invention;

FIG. 10A illustrates another embodiment of a distributed DC power source conversion module of the invention;

FIG. 10B illustrates a control flowchart of the distributed DC power source conversion module 1000 shown in FIG. 10A;

FIG. 10C illustrates another embodiment of a distributed DC power source conversion module of the invention;

FIG. 10D is a waveform of the positive perturb sampling switcher, the negative perturb sampling switcher, the positive sampling switcher and the negative sampling switcher shown in FIG. 10C;

FIG. 11 is a relationship of the output voltage VOUT and the duty cycle of the buck converter in the DC power source conversion module;

FIG. 12A illustrates an embodiment of a power harvesting system of the invention;

FIG. 12B illustrates another embodiment of a power harvesting system of the invention;

FIG. 13A illustrates an embodiment of a power harvesting system of the invention;

FIG. 13B illustrates an embodiment of a power harvesting system 1300 of the invention in a non-ideal condition;

FIG. 14A illustrates another embodiment of a power harvesting system of the invention; and

FIG. 14B illustrates that the power harvesting system 1400, shown in FIG. 14A, is operated in a non-ideal condition.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

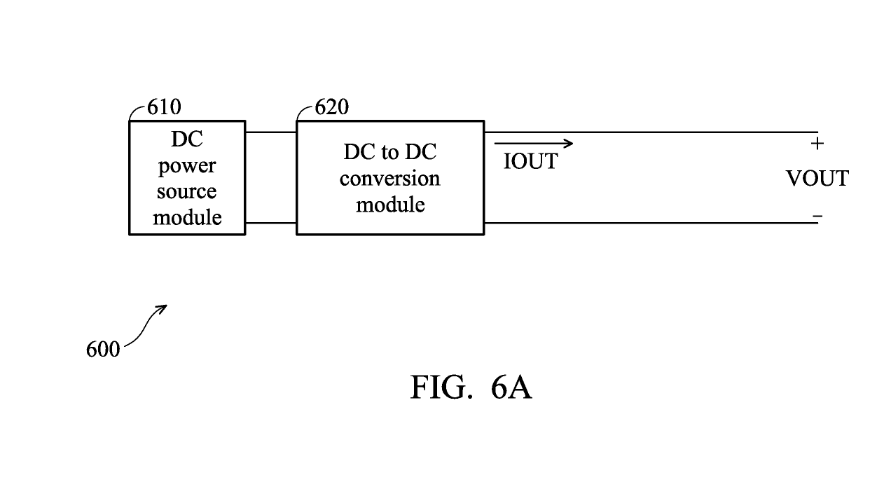

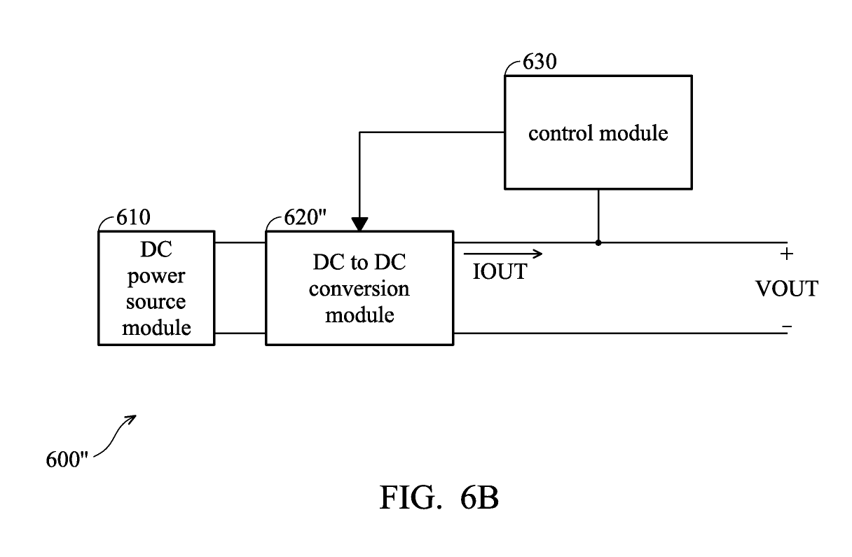

FIG. 6A illustrates an embodiment of a distributed DC power source conversion module of the invention, wherein the distributed DC power source conversion module has output characteristics of the maximum power range (MPR). In this embodiment, the distributed DC power source conversion module 600 can be a DC power source conversion module, for example, PV conversion module, but is not limited thereto. The distributed DC power source conversion module 600 includes a DC power source module 610. In some embodiments, the DC power source module 610 can be a photovoltaic module, a photovoltaic sub-module (photovoltaic string), a photovoltaic cell, and can be replaced by another type of DC power sources, for example, a fuel cell or a vehicle battery, but is not limited thereto.

As shown in FIG. 6A, the distributed DC power source conversion module 600 includes a DC power source module 610 (e.g., a photovoltaic module) and a DC to DC conversion module 620. The DC power source module 610 is composed of at least one photovoltaic cell, or portion of the photovoltaic panel (e.g., photovoltaic panel 210), but is not limited thereto. When the output current IOUT of the distributed DC power source conversion module 600 is a required current value, the output power of the distributed DC power source conversion module 600 has a maximum power range relative to the output voltage thereof. For example, when the output voltage VOUT is higher than a lower limit value, is lower than an upper limit value or is within a range, the output power of the distributed DC power source conversion module 600 is maintained essentially at a predetermined output power. In this embodiment, the predetermined output power is the maximum (output) power, but is not limited thereto. In other words, at this time, the output voltage VOUT has no need to be fixed at a particular value, but just to be in a range such that the output power of the distributed DC power source conversion module 600 is the maximum power. In addition, when the output voltage VOUT of the distributed DC power source conversion module 600 is a required voltage value, the output power of the distributed DC power source conversion module 600 has a maximum power range relative to the output current IOUT thereof. Similarly, the output current IOUT has no need to be fixed at a particular value, but just to be in a range such that the output power of the distributed DC power source conversion module 600 is the maximum power. The DC to DC conversion module 620 can be a pulse width modulation (PWM) conversion module or a resonant conversion module.

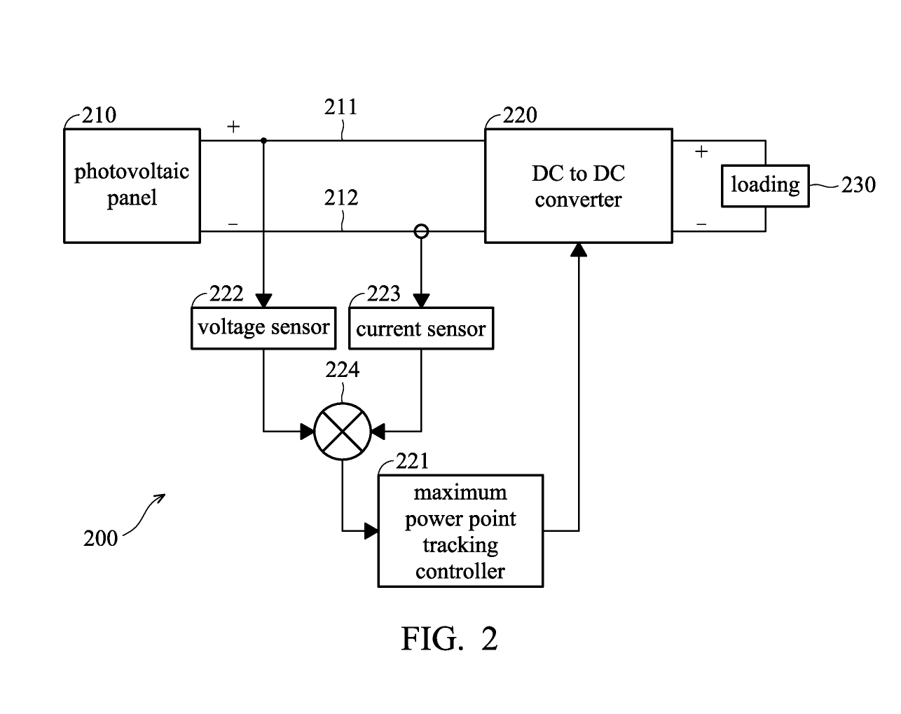

FIG. 6B illustrates another embodiment of a distributed DC power source conversion module of the invention. Compared to FIG. 6A, the DC to DC conversion module of the distributed DC power source conversion module 600″ is composed of a DC to DC conversion module 620″ and a control module 630. The control module 630 senses signals, responding to the output current IOUT or the output voltage VOUT in the distributed DC power source conversion module 600″, that are the signals responding to the output current IOUT or the output voltage VOUT of the DC to DC conversion module 620″ (e.g., the output current IOUT signal or the output voltage VOUT signal). The control module 630 controls the duty cycle or the working frequency of the DC to DC conversion module 620″ according to the sensed signal responding to the output current IOUT or the output voltage VOUT, such that the output power of the DC to DC conversion module 620″ is essentially a predetermined output power. In this embodiment, the predetermined output power is the maximum (output) power, but is not limit thereto. At this moment, the output power of the distributed DC power source conversion module 600″ is also the maximum power. The prior art shown in FIG. 2 needs two sensors to sense the output current and the output voltage of the photovoltaic module, and then generates the product of the output current and the output voltage by the multiplier. However, in this embodiment, the DC to DC conversion module 620″ is controlled by one of the sensed output current and the sensed output voltage to enable the distributed DC power source conversion module 600″ to operate with the maximum power point. In this embodiment, when the DC to DC conversion module 620′ is operated with the maximum power point, both the distributed DC power source conversion module 600″ and the DC power source module 610 (e.g., photovoltaic modules, photovoltaic sub-modules or photovoltaic cells) are operated with the maximum power point. Therefore, compared to the prior art shown in FIG. 2, this embodiment is more simply and has lower cost.

In the distributed DC power source conversion module of this embodiment shown in FIG. 6B, the DC to DC conversion module of the distributed DC power source conversion module 600″ is composed of a DC to DC conversion module 620″ and a control module 630, in which the control module 630 senses a responding signal of the DC to DC conversion module and control the DC to DC converter according to the sensed responding signal such that the DC power source conversion module is operated at a predetermined output power, in which the responding signal responds to the output signal of the DC to DC converter. When the value of the output signal is within a predetermined range, the DC power source conversion module is operated with the predetermined power, for example, the maximum output power. Therefore, compared to the prior art shown in FIG. 2, this embodiment is more simply and has lower cost, and the output of the maximum power is within a range not a point such that the distributed DC power source conversion module 600″ is easy to be controlled and operated.

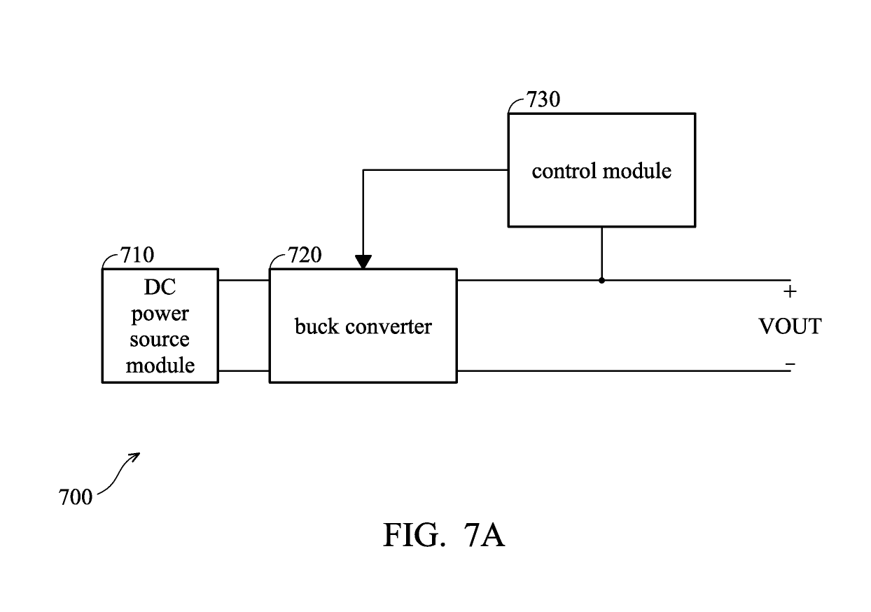

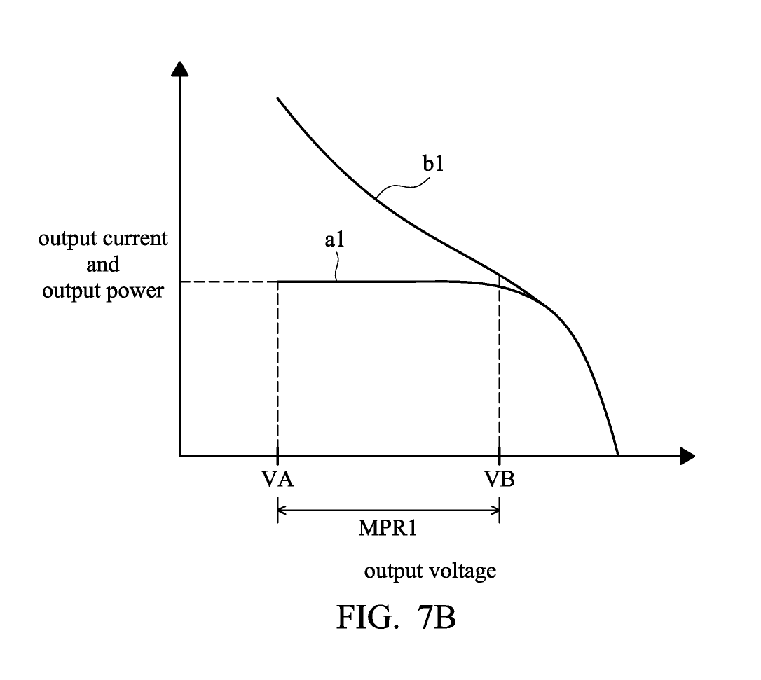

FIG. 7A illustrates another embodiment of a distributed DC power source conversion module of the invention. In this embodiment, the distributed DC power source conversion module 700 includes a DC power source module 710 (e.g., photovoltaic modules, photovoltaic sub-modules or photovoltaic cells), a buck converter 720 and a control module 730. The buck converter 720 is powered by the DC power source module 710. Namely, the buck converter 720 receives electric power/energy (e.g., voltage and current) from the DC power source module 710. The control module 730 senses the output voltage VOUT of the buck converter 720, and then controls the duty cycle of the buck converter 720 according the sensed output voltage VOUT, such that the distributed DC power source conversion module 700 is operated within the maximum power range MPR1 and the DC power source module 710 is also operated with the maximum power point at the same time. In this embodiment, the buck converter 720 and the control module 730 form a DC to DC conversion module having the maximum power range. In some embodiments, the control module 730 can senses signal responding to the output current IOUT or the output voltage VOUT in the distributed DC power source conversion module 700, e.g., the output current IOUT of the buck converter 720, but is not limited thereto.

FIG. 7B illustrates the characteristic curve indicating the output current and the output power relative to the output voltage in the distributed DC power source conversion module 700. As shown in FIG. 7B, a curve al is the characteristic curve indicating the output power relative to the output voltage VOUT in the distributed DC power source conversion module 700. For a predetermined condition, as long as the control module 730 controls the output of the buck converter 720, the DC power source module 710 is operated with the maximum power point thereof without controlling the output of the DC power source module 710. In other words, in this embodiment, the maximum power range of the distributed DC power source conversion module 700 is used to replace the maximum power of the DC power source module 710. Compared with the maximum power point of the DC power source module 710, the DC power source module 710 is easily operated with the maximum power point by the use of the maximum power range of the distributed DC power source conversion module 700. As shown in FIG. 7B, when the output voltage VOUT of the buck converter 720 is lower than a voltage range of a voltage VB (e.g., the range between the voltage VA to the voltage VB, in which the voltage VA can be infinitely small, close to zero), the distributed DC power source conversion module 700 is operated with the maximum power point. In other words, the distributed DC power source conversion module 700 has the maximum power range MPR1 rather than a maximum power point. Therefore, as long as the control module 730 controls the output voltage VOUT of the distributed DC power source conversion module 700 with a voltage VB corresponding to the maximum power range MPR1, the DC power source module 710 is easily operated with the maximum power point. In addition, a curve b1 is the characteristic curve indicating the output current relative to the output voltage VOUT in the distributed DC power source conversion module 700. In some embodiments, the control module 730 senses the output current IOUT of the buck converter 720 and controls the duty cycle or the work frequency of the buck converter according to the sensed output current IOUT, such that the distributed DC power source conversion module 700 is operated within the maximum power range.

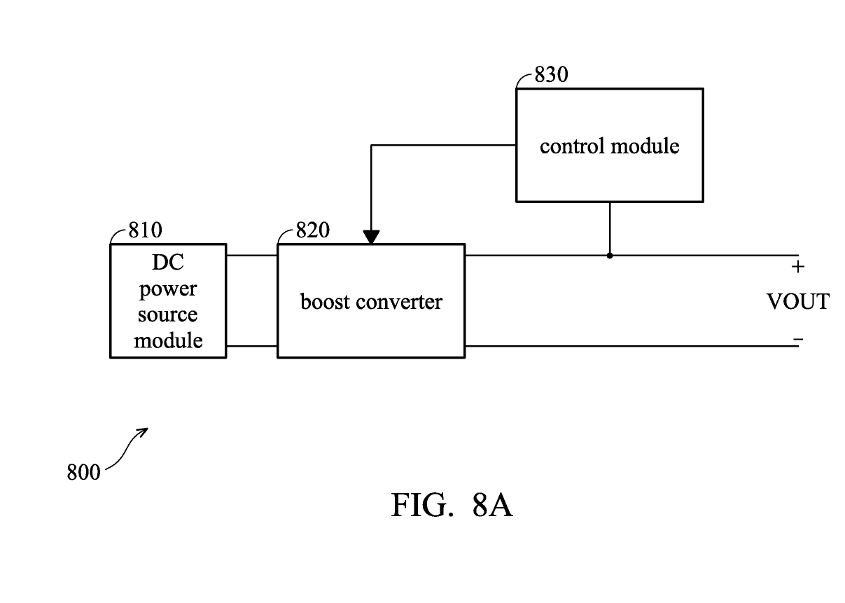

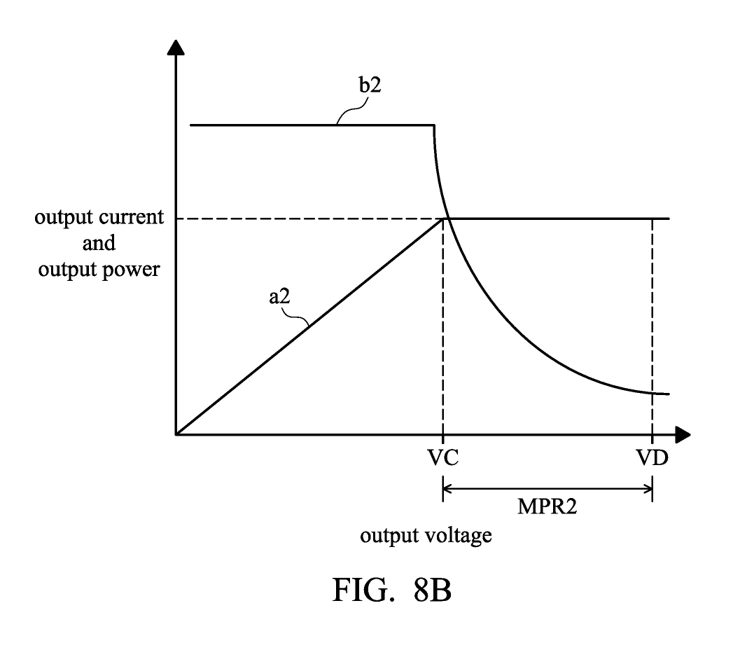

FIG. 8A illustrates another embodiment of a distributed DC power source conversion module of the invention. In this embodiment, the distributed DC power source conversion module 800 includes a DC power source module (e.g., photovoltaic modules, photovoltaic sub-modules or photovoltaic cells) 810, a boost converter 820 and a control module 830. The boost converter 820 is powered by the DC power source module 810. That is, the boost converter 820 receives electric power/energy from the DC power source module 810. The control module 830 senses the output voltage VOUT of the boost converter 820 and controls the duty cycle of the boost converter 820 according to the sensed output voltage VOUT, such that the distributed DC power source conversion module 800 is operated within the maximum power range MPR2 and the DC power source module 810 is operated with the maximum power point at the same time. In this embodiment, a DC to DC conversion module, having the maximum power range, is composed of the boost converter 820 and the control module 830. In some embodiments, the control module 830 can sense signals responding to the output current IOUT or the output voltage VOUT in the distributed DC power source conversion module 800, for example, the output current IOUT of the boost converter 820, but is not limited thereto.

FIG. 8B illustrates the characteristic curve indicating the output current and the output power relative to the output voltage VOUT in the distributed DC power source conversion module 800. As shown in FIG. 8B, a curve a2 is the characteristic curve indicating the output power relative to the output voltage VOUT in the distributed DC power source conversion module 800. For a predetermined condition, as long as the control module 830 controls the output voltage VOUT of the boost converter 820, the DC power source module 810 is operated with the maximum power point without the control of the output of the DC power source module 810. In other words, in this embodiment, the maximum power range of the distributed DC power source conversion module 800 is used to replace the maximum power point of the DC power source module 810. Compared with the maximum power point of the DC power source module 810, the DC power source module 810 is easily operated with the maximum power point by the use of the maximum power range of the distributed DC power source conversion module 800. As shown in FIG. 8B, when the output voltage VOUT of the boost converter 820 is higher than a voltage range of a voltage VC (e.g., the range between the voltage VC to the voltage VD), the distributed DC power source conversion module 800 is operated with the maximum power point. In other words, the distributed DC power source conversion module 800 has the maximum power range MPR2 rather than a maximum power point. A curve b2 is the characteristic curve indicating the output current relative to the output voltage VOUT in the distributed DC power source conversion module 800. In some embodiments, the control module 830 senses the output current IOUT of the boost converter 820 and controls the duty cycle or the work frequency of the boost converter 820 according to the sensed output current IOUT, such that the distributed DC power source conversion module 800 is operated within the maximum power range.

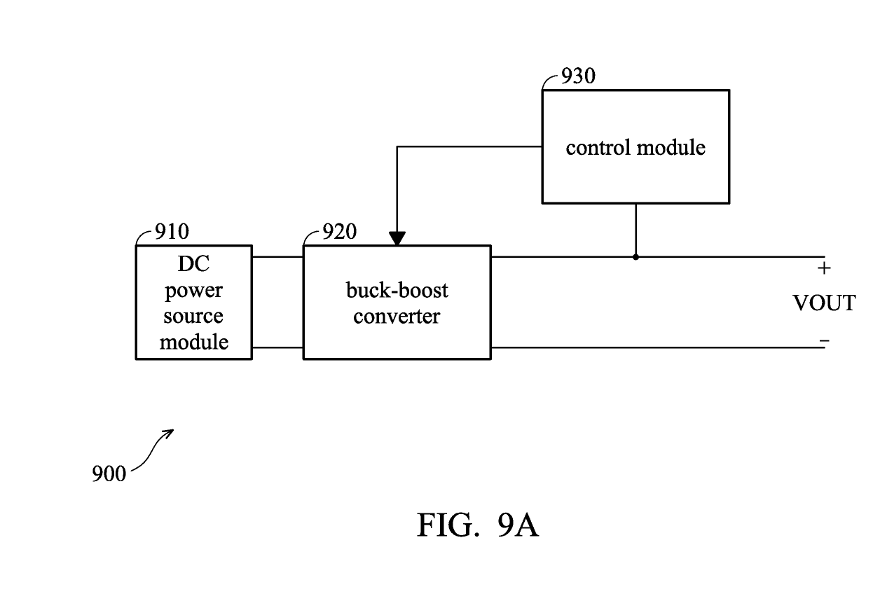

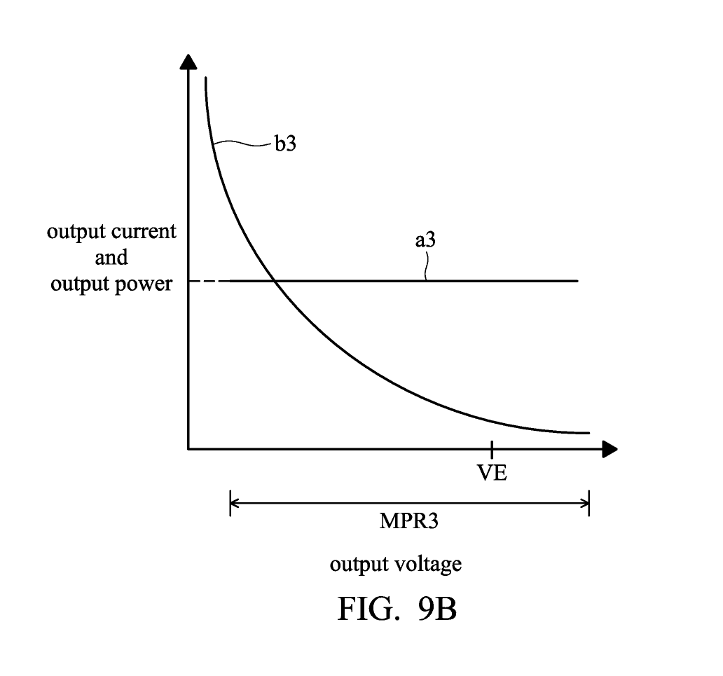

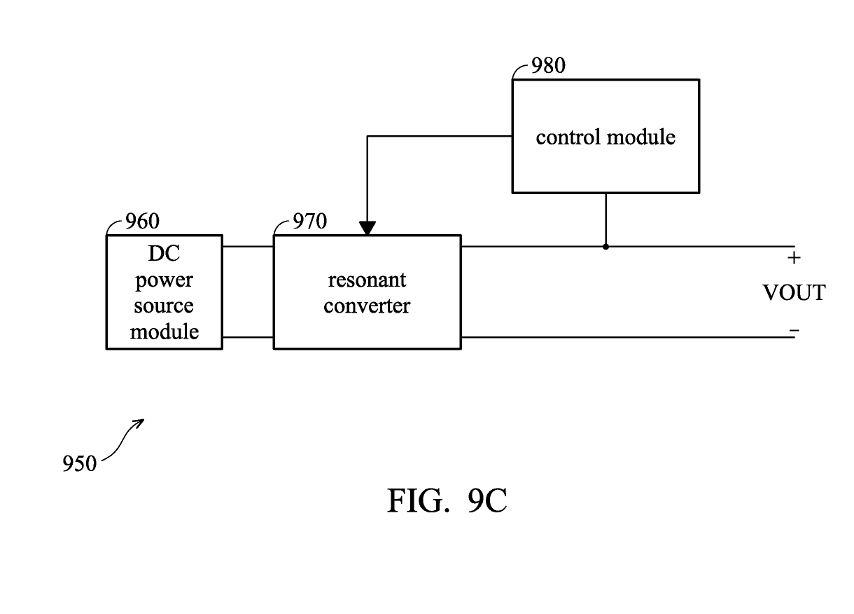

FIG. 9A illustrates another embodiment of a distributed DC power source conversion module of the invention. In this embodiment, the distributed DC power source conversion module 900 includes a DC power source module 910, a buck-boost converter 920 and a control module 930. The buck-boost converter 920 is powered by the DC power source module 910. Namely, the buck-boost converter 920 receives electric power/energy from the DC power source module 910. The control module 930 senses the output voltage VOUT of the buck-boost converter 920 and controls the duty cycle of the buck-boost converter 920 according to the sensed output voltage VOUT, such that the distributed DC power source conversion module 900 is operated within the maximum power range and the DC power source module 910 is operated with the maximum power point at the same time. In this embodiment, a DC to DC conversion module, having the maximum power range, is composed of the buck-boost converter 920 and the control module 930. In some embodiments, the control module 930 can sense signals responding to the output current IOUT or the output voltage VOUT in the distributed DC power source conversion module 900, for example, the output current IOUT of the buck-boost converter 920, but is not limited thereto.

FIG. 9B illustrates the characteristic curve indicating the output current and the output power relative to the output voltage VOUT in the distributed DC power source conversion module 900. As shown in FIG. 9B, a curve a3 is the characteristic curve indicating the output power relative to the output voltage VOUT in the distributed DC power source conversion module 900. For a predetermined condition, as long as the control module 930 controls the output voltage VOUT of the buck-boost converter 920, the DC power source module 910 is operated with the maximum power point without control of the output of the DC power source module 910. In other words, in this embodiment, the maximum power range of the distributed DC power source conversion module 900 is used to replace the maximum power point of the DC power source module 910. Compared with the maximum power point of the DC power source module 910, the DC power source module 910 is easily operated with the maximum power point by the use of the maximum power range of the distributed DC power source conversion module 900. As shown in FIG. 9B, no matter whether the output voltage VOUT of the buck-boost converter 920 is higher than or lower than a voltage range of a voltage VE, the distributed DC power source conversion module 900 can be operated with the maximum power point. In other words, the distributed DC power source conversion module 900 has the maximum power range MPR3 (in theory, all voltage range) rather than a maximum power point. A curve b3 is the characteristic curve indicating the output current relative to the output voltage VOUT in the distributed DC power source conversion module 900. In some embodiments, the control module 930 senses the output current IOUT of the buck-boost converter 920 and controls the duty cycle or the work frequency of the boost converter according to the sensed output current IOUT, such that the distributed DC power source conversion module 900 is operated within the maximum power range.

FIG. 9C illustrates another embodiment of a distributed DC power source conversion module of the invention. In this embodiment, the distributed DC power source conversion module 950 includes a DC power source module 960, a resonant converter 970 and a control module 980. The resonant converter 970 is powered by the DC power source module 960. Namely, the resonant converter 970 receives electric power/energy from the DC power source module 960. The control module 980 senses the output voltage VOUT of the resonant converter 970 and controls the work frequency of the resonant converter 970 according to the sensed output voltage VOUT, such that the distributed DC power source conversion module 950 is operated within the maximum power range and the DC power source module 960 is operated with the maximum power point at the same time. In this embodiment, a DC to DC conversion module, having the maximum power range, is composed of the resonant converter 970 and the control module 980. In some embodiments, the control module 980 can sense signals responding to the output current IOUT or the output voltage VOUT in the distributed DC power source conversion module 950, for example, the voltage on the resonant capacitor (also known as resonant capacitance voltage) of the resonant converter 970, or one or more than one of currents of high frequency transformers (e.g., excitation Inductor current, transformer primary side winding current or transformer secondary side winding current), but are not limited thereto.

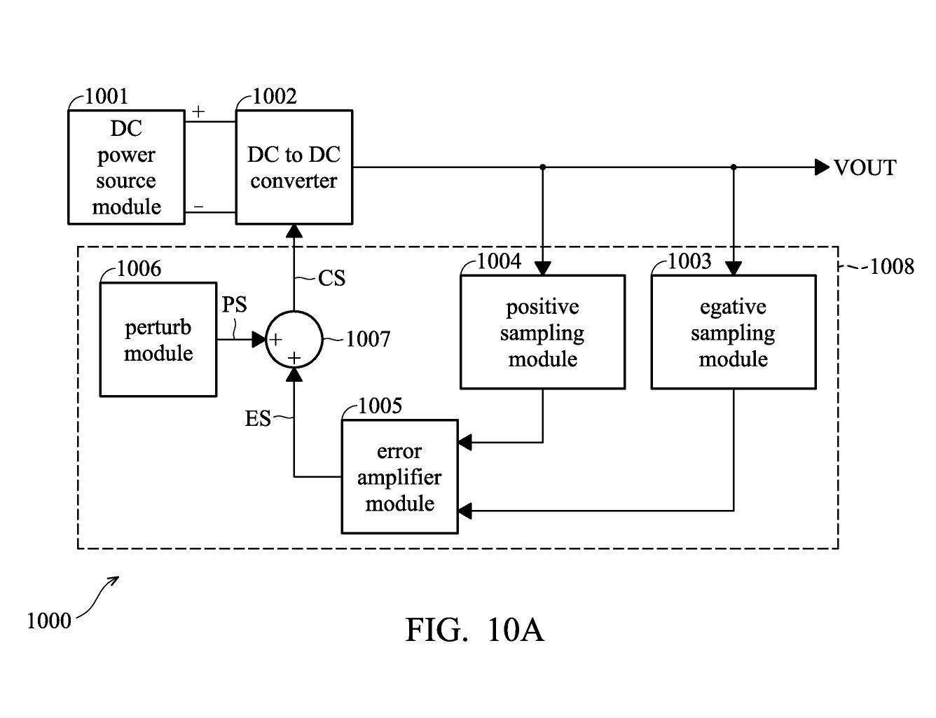

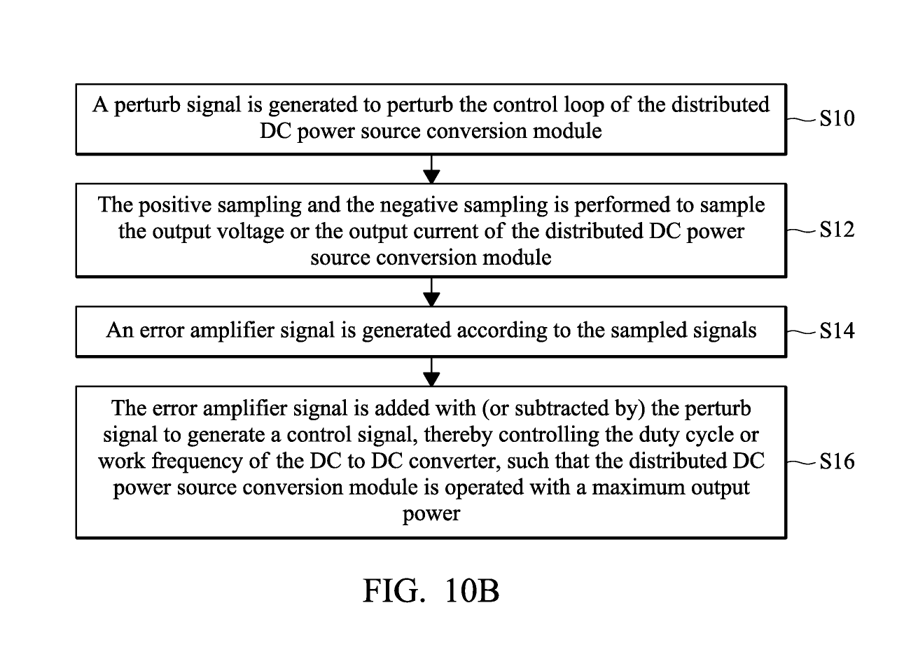

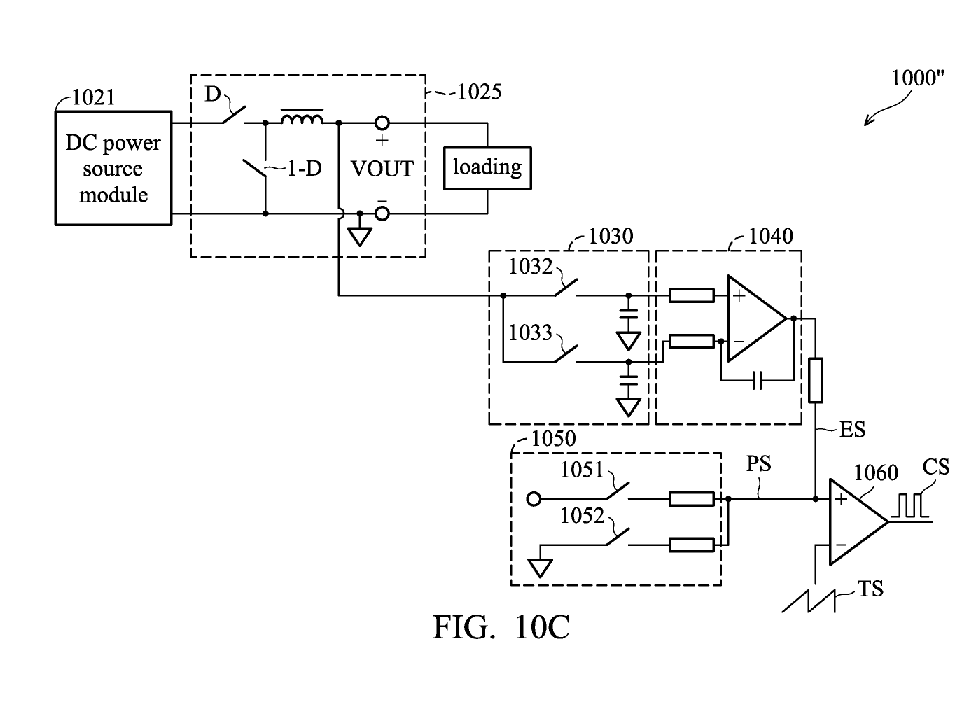

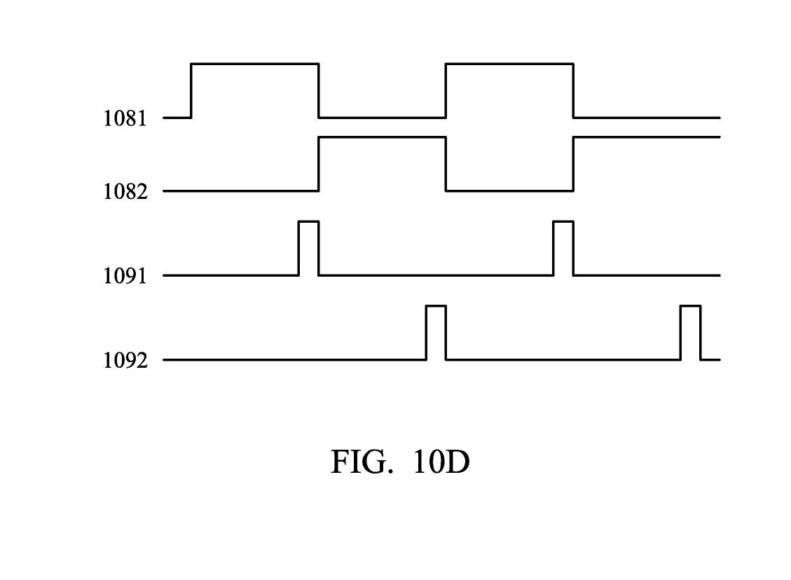

FIG. 10A illustrates another embodiment of a distributed DC power source conversion module of the invention. In this embodiment, the distributed DC power source conversion module 1000 includes a DC power source module (e.g., photovoltaic modules, photovoltaic sub-modules or photovoltaic cells) 1001, a DC to DC converter 1002 and a control module 1008. The control module 1008 includes a perturb module 1006 and a control loop. The DC to DC converter 1002 is powered by the DC power source module 1001. The control module 1008 samples the output voltage VOUT (or output current) of the DC to DC converter 1002 to control the DC to DC converter 1002. The control module 1008 includes a negative sampling module 1003, a positive sampling module 1004, an error amplifier module 1005 and a perturb module 1006. The control loop includes the negative sampling module 1003, the positive sampling module 1004 and the error amplifier module 1005. The perturb module 1006 provides a perturb signal PS to perturb the duty cycle or work frequency of the DC to DC converter 1002 and the perturb signal PS affects the output voltage VOUT (or the output current) of the DC to DC converter 1002. The positive sampling module 1004 and the negative sampling module 1003 are coupled to the output terminal of the DC to DC converter 1002 to sample the output of the DC to DC converter 1002 (e.g., the output voltage VOUT or the output current). In some embodiments, the positive sampling module 1004 and the negative sampling module 1003 can be coupled to the other portion of the DC to DC converter 1002 as long as the positive sampling module 1004 and the negative sampling module 1003 can sample the responding signal (responding output current signal or output voltage signal). The error amplifier module 1005 generates an error amplifier signal ES according to the signal sampled by the positive sampling module 1004 and the negative sampling module 1003. The perturb signal PS of the perturb module 1006 and the error amplifier signal ES are delivered to a combination module (e.g., a comparator) 1007 to perform an addition (or a subtraction) and compared with a triangular wave or a saw tooth wave to generate a control signal CS, thereby controlling the duty cycle or work frequency of the DC to DC converter 1002.

In another embodiment, the control module 1008 shown in FIG. 10A can be implemented by integral circuits, but is not limited thereto. In some embodiments, the control module 1008 shown in FIG. 10A can be implemented by software programs of digital processors. FIG. 10B illustrates a control flowchart of the distributed DC power source conversion module 1000 shown in FIG. 10A. First, in step S10, a perturb signal is generated to perturb the control loop of the distributed DC power source conversion module 1000. For example, the step of perturbing the control loop includes a high level voltage (e.g., a fixed voltage) being coupled to the control loop for a fixed period T1, and a low level voltage (e.g., a ground voltage) being coupled to the control loop for a fixed period T2, in which the high level voltage and the low level voltage are staggered to be coupled to the control loop. In step S12, the positive sampling and the negative sampling is performed to sample the output voltage or the output current of the distributed DC power source conversion module 1000. For example, when the high level voltage (e.g., a fixed voltage) is coupled to the control loop, the positive sampling is performed to generate a first sampling signal. When the low level voltage (e.g., a ground voltage) is coupled to the control loop, the negative sampling is performed to generate a second sampling signal. Next, in step S14, an error amplifier signal is generated according to the sampled signals. Finally, in step S16, the error amplifier signal is added with (or subtracted by) the perturb signal to generate a control signal, thereby controlling the duty cycle or work frequency of the DC to DC converter 1002, such that the distributed DC power source conversion module 1000 is operated with a maximum output power.

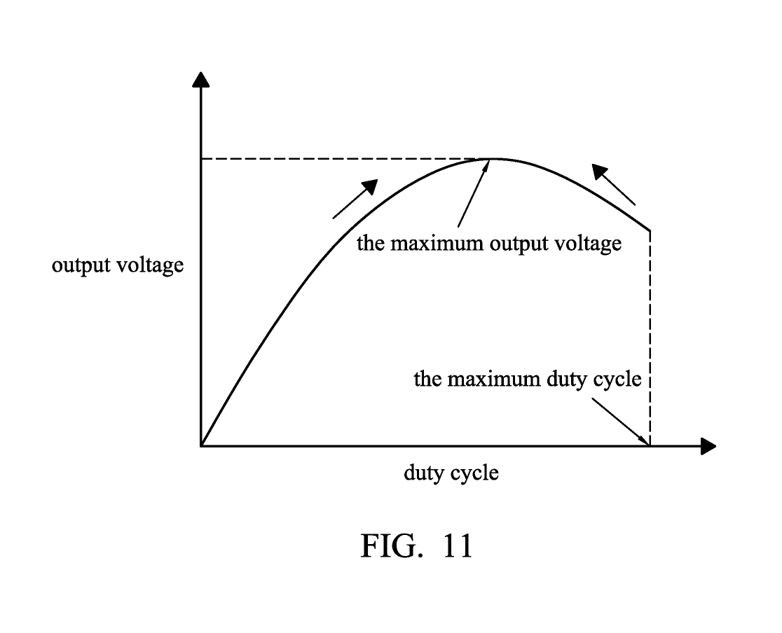

FIG. 10C illustrates another embodiment of a distributed DC power source conversion module of the invention. As shown in FIG. 10C, the distributed DC power source conversion module 1000″ includes a DC power source module 1021, a buck converter 1025, a sampling module 1030, an error amplifier module 1040, a perturb module 1050 and a comparator 1060. In some embodiments, the buck converter 1025 can be replaced with another type of converter, for example, a boost converter, a buck-boost converter, a flyback converter, a forward converter or a resonant converter, but is not limited thereto. Furthermore, the sampling module 1030, the error amplifier module 1040, the perturb module 1050 and the comparator 1060 can be as an embodiment of the control module 1008 shown in FIG. 10A. The DC power source module 1021 provides power to the buck converter 1025. The sampling module 1030 is coupled to the output terminal of the buck converter 1025 to sense the output voltage VOUT of the buck converter 1025. The sampling module 1030 includes a positive sampling switcher 1032 and a negative sampling switch 1033 to sample the output voltage VOUT of the buck converter 1025. The output voltage VOUT sampled by the sampling module 1030 is delivered to the error amplifier module 1040. The error amplifier module 1040 can be a scalar amplifier, an integral amplifier or a differential amplifier to generate an error amplifier signal ES according to the output voltage sampled by the sampling module 1030. For example, the error amplifier module 1040 can include an integral capacitor for integration. The perturb module 1050 includes a positive perturb switcher 1051 and a negative perturb switcher 1052 to generate a perturb signal PS. The perturb signal PS and the error amplifier signal ES are inputted to the positive terminal of the comparator 1060 to perform an addition operation. The comparator 1060 compares the product of the perturb signal PS and the error amplifier signal ES with a triangle wave signal TS of the negative terminal to generate a control signal CS to decrease the duty cycle of the buck converter 1025. In this embodiment, the comparator 1060 serves as the combination unit shown in FIG. 10A. FIG. 10D is a waveform of the positive perturb sampling switcher, the negative perturb sampling switcher, the positive sampling switcher and the negative sampling switcher shown in FIG. 10C. As shown in FIG. 10D, waveforms 1081 and 1082 are the switching waveforms of the positive perturb switcher 1051 and the negative perturb switcher 1052, respectively. Waveforms 1091 and 1092 are the switching waveforms of the positive sampling switcher 1032 and the sampling switcher 1033, respectively. In this embodiment, the positive sampling switcher 1032 and the negative sampling switcher 1033 alternately perform sampling, and the sampling frequency of the positive sampling switcher 1032 and the negative sampling switcher 1033 is much lower than the switching frequency of the buck converter 1025. For example, the switching frequency of the buck converter 1025 is 500 KHz and the sampling frequency of the positive sampling switcher 1032 and the negative sampling switcher 1033 is 20 KHz. In some embodiments, the positive sampling switcher 1032 and the sampling switcher 1033 can be a positive sampling module and a negative sampling module, respectively. FIG. 11 is a relationship of the output voltage VOUT and the duty cycle of the buck converter in the DC power source conversion module.

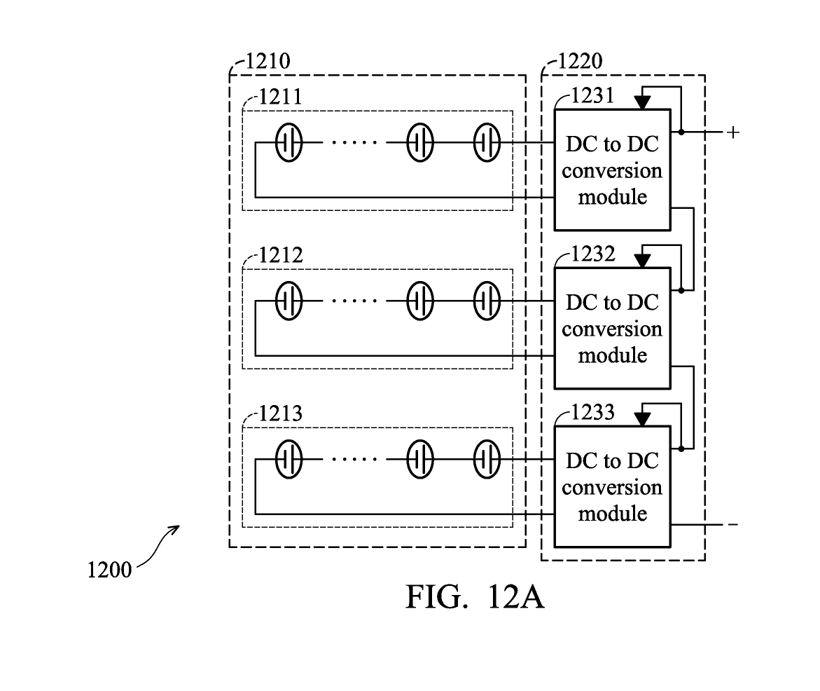

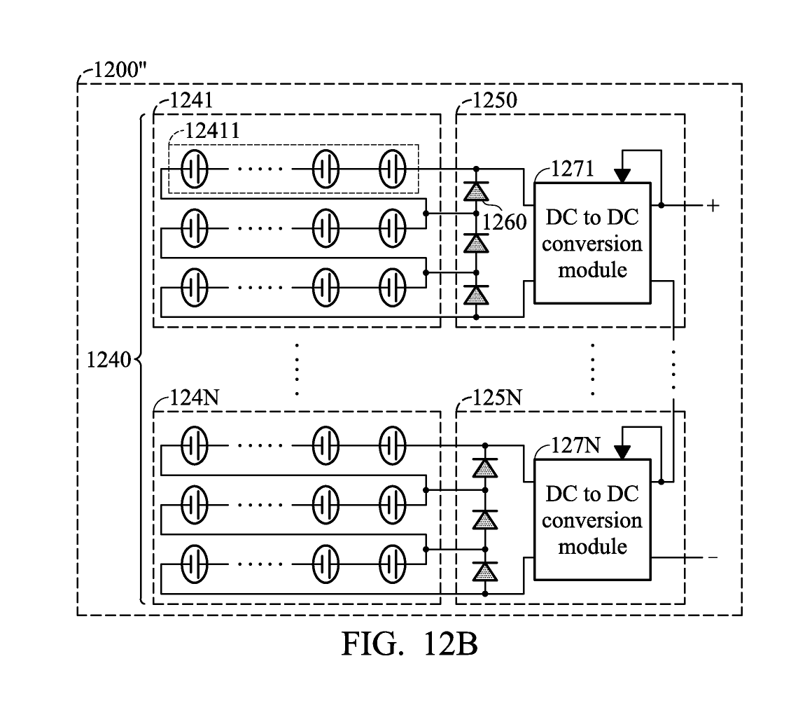

FIG. 12A illustrates an embodiment of a power harvesting system of the invention. As shown in FIG. 12A, the power harvesting system 1200 includes a photovoltaic module 1210 and a junction box 1220. The photovoltaic module 1210 is composed of several photovoltaic sub-modules (i.e., photovoltaic cell strings) 1211-1213. Each photovoltaic sub-module (i.e., photovoltaic cell string) is composed of several (e.g., 18-20) photovoltaic cells connected in series. The junction box 1220 includes several DC to DC conversion modules 1231-1233 having the maximum power range. The outputs of the DC to DC conversion modules 1231-1233 are coupled in series. Each DC to DC conversion module is powered by the corresponding photovoltaic sub-module thereby receiving electric power/energy from the corresponding photovoltaic sub-module. The operations of the DC to DC conversion modules 1231-1233 are similar to the operation the DC to DC conversion modules shown in FIG. 6A, 6B, 7A, 8A, 9A, 9C, 10A and 10C, therefore the operations of the DC to DC conversion modules 1231-1233 are omitted for brevity.

FIG. 12B illustrates another embodiment of a power harvesting system of the invention. As shown in FIG. 12B, the power harvesting system 1200″ includes a photovoltaic module string 1240 and junction boxes 1250-125N. The photovoltaic module string 1240 is composed of several photovoltaic modules 1241-124N. Each photovoltaic module is composed of photovoltaic sub-modules 12411 connected in series. The photovoltaic sub-modules 12411 are composed of several photovoltaic cells connected in series. Each photovoltaic module 12411 is coupled to a junction box. The junction box 1250 includes a DC to DC conversion module 1271 having the maximum power range and several bypass diodes 1260. The DC to DC conversion modules 1271-127N are coupled in series, and each DC to DC conversion module is powered by a corresponding photovoltaic module, thereby receiving electric power/energy from the corresponding photovoltaic module. In general, in the photovoltaic sub-module 12411, the number of the photovoltaic is 18-20, but is not limited thereto. In addition, compared to the embodiment shown in FIG. 12A, the junction box 1250 further includes bypass diode strings composed of several bypass diodes 1260 connected in series. Each the bypass diode string is coupled between two terminals of the corresponding DC to DC conversion modules. In this embodiment, each photovoltaic sub-module 12411 is coupled to a corresponding bypass diode 1260 and the anode of the bypass diode 1260 is coupled to the negative terminal of the corresponding photovoltaic sub-module 12411. The cathode of the bypass diode 1260 is coupled to the positive terminal of the corresponding photovoltaic sub-module 12411. In some embodiments, only one bypass diode 1260 is connected between two of the DC to DC conversion modules. The operations of the distributed DC to DC conversion modules 1271-127N are similar to the DC to DC conversion modules shown in FIG. 6A, 6B, 7A, 8A, 9A, 9C, 10A and 10C, therefore the operations of the distributed DC to DC conversion modules 1271-127N are omitted for brevity.

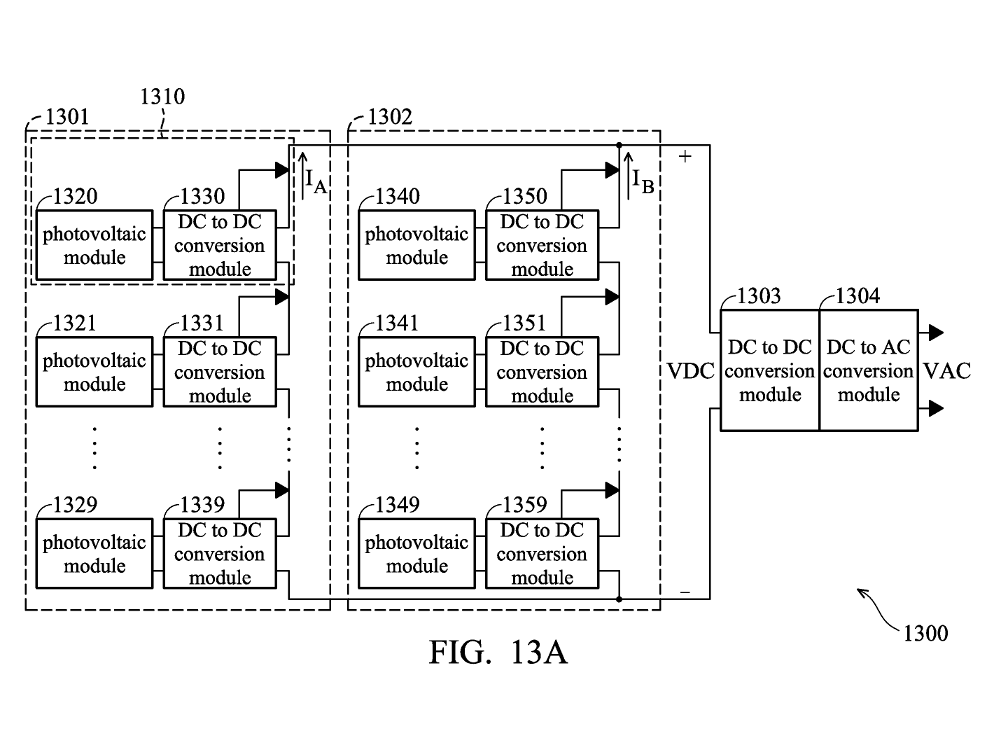

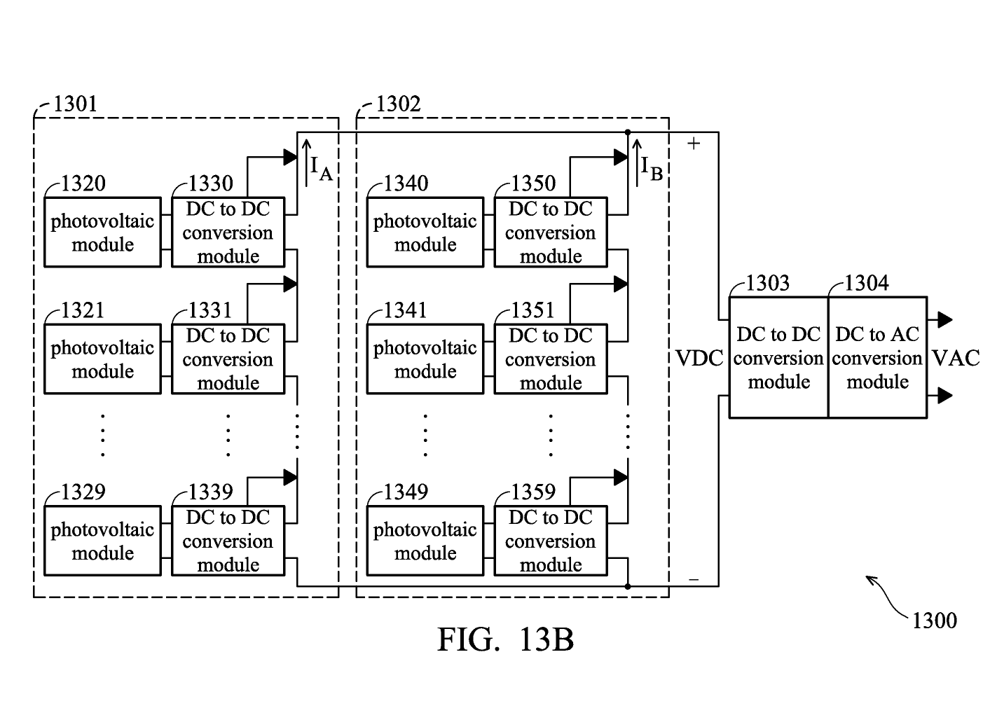

FIG. 13A illustrates another embodiment of a power harvesting system of the invention. As shown in FIG. 13A, the power harvesting system 1300 includes two DC power source conversion module strings 1301 and 1302, a second DC to DC conversion module having the maximum power point tracking and a DC to AC conversion module 1304. Note that in this embodiment, the power harvesting system 1300 includes two DC power source conversion module strings 1301 and 1302 for description, but is not limited thereto. In some embodiments, the power harvesting system 1300 can include more than two DC power source conversion module strings 1301 and 1302.

Each of the DC power source conversion module strings 1301 and 1302 is composed of several photovoltaic modules and several DC to DC conversion modules have the maximum power range, in which, for illustration of the connection of the photovoltaic modules and the DC to DC conversion modules, please refer to FIG. 12A or FIG. 12B. For example, the DC power source conversion module string 1301 includes photovoltaic modules 1320-1329 and DC to DC conversion modules 1330-1339, and the DC power source conversion module string 1302 includes photovoltaic modules 1340-1349 and DC to DC conversion modules 1350-1359. Furthermore, each photovoltaic module is connected to a corresponding DC to DC conversion module to form a photovoltaic conversion module. For example, the photovoltaic module 1310 is composed of the photovoltaic module 1320 and the DC to Dc conversion module 1330. The photovoltaic conversion modules (e.g., 1310) are connected in series to form the DC power source conversion module strings 1301 and 1302. In some embodiments, the photovoltaic modules 1320-3219 and 1340-1349, and the DC to DC conversion modules 1330-1339 and 1350-1359 are disposed outdoors, in which the DC to DC conversion modules 1330-1339 and 1350-1359 are disposed in the junction box. As described above, the photovoltaic conversion module of the invention has the characteristic of the maximum power range, so the power of the connected photovoltaic module is optimized easily and the electric power/energy from the input terminal of the DC to DC conversion module is converted effectively. In some embodiments, the photovoltaic module can be replaced with another type DC power source, for example, fuel cells or vehicle batteries, but is not limited thereto.

Each of the DC to DC conversion modules 1330-1339 and 1350-1359 includes a DC to DC converter and a control module and are powered by a corresponding photovoltaic conversion module to output an output signal (i.e., the output voltage and/or output current signal). The control module receives the output voltage or the output current of the photovoltaic conversion module to serve as a feedback signal for controlling the DC to DC converter. For example, the DC to DC conversion modules 1330-1339 and 1350-1359 can be PWM converters, for example, boost converters, buck-boost converters, flyback converters or forward converters, or resonant converters such as LLC resonant converters or parallel resonant converters, but are not limited thereto. For example, the control module is a maximum power range (MPR) control module. Each of the maximum power range (MPR) control modules of the DC to DC conversion modules 1330-1339 and 1350-1359 can easily enable the photovoltaic modules to be operated with the maximum power point. For example, each of the DC to DC conversion modules 1330-1339 and 1350-1359 can be the DC to DC conversion modules shown in FIG. 6A, 6B, 7A, 8A, 9A, 9C, 10A and 10C, but are not limited thereto.

The DC to DC conversion module 1303, having the maximum power point tracking, extracts power/energy from the DC power source conversion module strings 1301 and 1302 and converts the power/energy to the input voltage of the DC to AC conversion module 1304. The second DC to DC conversion module 1303 receives the current extracted by the photovoltaic conversion modules and tracks the current to the maximum power point, thereby providing a maximum average power. Therefore, if too much current is extracted, the average voltage from the photovoltaic conversion module is decreased in order to reduce the harvested power/energy. In other words, the second DC to DC conversion module 1303 maintains the current in order to enable the power harvesting system 1300 to generate the maximum average power.

The solar radiance, environment temperature, the shadow of near objects (e.g., trees) or the shadow of distant objects (e.g. cloud) affect the energy received by the photovoltaic modules. The energy received by the photovoltaic modules is varied according the use of the type and the number of photovoltaic modules. Therefore, it is difficult for owners and even professional installers to verify the correct operation of this system. Furthermore, as time changes, many factors (e.g., aging, accumulation of dust and pollutants and degradation of the modules) will affect the performance of the photovoltaic modules.

This embodiment of the invention can overcome the related problem. For example, in the system, mismatched power sources can be connected in series, for example, the mismatch photovoltaic modules (panels), different types or photovoltaic modules with non-rated powers, or even the photovoltaic modules from different manufacturers or photovoltaic modules made of different semiconductor materials. In the system of this embodiment, the power sources operated in different conditions (e.g., the photovoltaic modules irradiated by different sunshine intensities or the photovoltaic modules at different temperatures) are allowed to be connected in series. In this embodiment, the power sources are allowed to be disposed in different directions or in different locations. The advantage described above will be illustrated below.

In an embodiment, the outputs of the DC to DC conversion modules 1330-1339 and 1350-1359 are connected in series to a single DC voltage VDC to serve as the loading or the input of the power supply (e.g., the second DC to DC conversion module 1303 having the maximum power point tracking) The DC to AC conversion module 1304 converts the DC voltage from the second DC to DC conversion module 1303 to the required AC voltage VAC. For example, the AC voltage VAC can be 110V or 220V with 60 Hz or 220V with 50 Hz. Note that there are many converters to generate 220V AC voltage in U.S., but 220V AC voltage is separated into two 110V AC voltages before feeding the electric box. The AC voltage VAC generated by the DC to AC converter 1304 can be used in for operation of electrical products or fed into the power network or stored in a battery by a conversion and charge/discharge circuit. The DC to AC conversion module 1304 can be omitted in the battery-based application. The DC output of the second DC to DC conversion module 1303 is stored in the battery by a charge/discharge circuit.

In general, the input voltage of the loading (e.g., the DC to DC converter or the AC to DC converter) is allowed to vary according to the available power. For example, when the photovoltaic system is irradiated by hot sun with high intensity, the input voltage of the converter may be higher than 1000V. In other words, the voltage is varied according to the sunshine intensity, and the electronic device of the converter should support unstable voltage. Therefore, degradation of the characteristic of the electronic device may be generated. Finally, the electronic device will breakdown. On the other hand, by the fixed voltage or current input to the converter (or another power supply or loading), the electronic device only supports the same voltage or current, thereby extending the life of the electronic device. For example, the loading devices (e.g., capacitor, switcher and coil of the conversion module) are chosen such that the electronic device is operated with fixed voltage or current (e.g., 60% of the rated value). In this way, the reliability and the life of the electronic device is increased. The invention is critical for applications which prevent interruptions (e.g., photovoltaic power supply systems). In this embodiment, the input of the second DC to DC conversion module having the maximum power point tracking is variable, but the output thereof is fixed.

FIG. 13A and FIG. 13B illustrate the power harvesting system 1300 of the invention operated in different conditions.

As shown in FIG, 13A and FIG, 13B, the photovoltaic modules 1320-1329 are connected to ten DC to DC conversion modules 1330-1339. The photovoltaic conversion modules, composed of the photovoltaic modules (DC power source) 1320-1329 and the corresponding DC to DC conversion modules 1330-1339, are connected in series to a DC power source conversion module string 1301. In some embodiments, the DC to DC conversion modules 1330-1339, connected in series, are coupled to the second DC to DC conversion module 1303 having the maximum power point tracking, and the DC to AC conversion module 1304 is coupled to the output terminal of the second DC to DC conversion module 1303.

In this embodiment, the DC power source is an example for a photovoltaic module and illustrated with relative photovoltaic panels. In some embodiments, the photovoltaic module can be replaced with another type of DC power sources. In this embodiment, the photovoltaic modules 1320-1329 have different output powers due to process tolerance, shadow or another factor. FIG. 13A is an ideal example for illustration of the embodiment and assumes that the efficiency of the DC to DC conversion module is up to 100% and the photovoltaic modules 1320-1329 are all the same. In this embodiment, the efficiencies of the DC to DC conversion modules 1330-1339 are very high and in the range of 95%-99%. Therefore, it is unreasonable to assume that the efficiency is 100% for illustration. Furthermore, each of the DC to DC conversion modules 1330-1339 serves as a power source converter. Namely, the DC to DC conversion modules 1330-1339 convert the output into the output with a small energy loss.

The output power of each photovoltaic module is maintained with the maximum power point by the control module of the corresponding DC to DC conversion modules 1330-1339 and the control loop of the second DC to DC conversion module 1303 having the maximum power point tracking As shown in FIG. 13A, all the photovoltaic modules are fully irradiated by sun and each photovoltaic module can provide 200 W of power.

As described above, in this embodiment, the input voltage of DC to AC conversion module 1304 is controlled by the DC to DC conversion module (e.g., maintain in a fixed value). For example, in this embodiment, assuming that the input voltage of the DC to AC conversion module 1304 is 400V (i.e., the ideal voltage for the conversion of 200V AC voltage VAC), because each of the DC to DC conversion modules 1330-1339 provides 200 W of power, the input current provided to the DC to AC conversion module 1304 can be

$$\frac{10 \times 200 W}{400 V} = 5 A .$$

Therefore, the current I_{A} flowing through each of the DC to DC conversion modules 1330-1339 must be 5 A. This means that each of the DC to DC conversion modules 1330-1339 provides

$$\frac{200 W}{5 A} = 40 V$$

of the output voltage. Similarly, the current I_{B} flowing through each of the DC to DC conversion modules 1330-1339 must be 5 A. This means that each of the DC to DC conversion modules 1350-1359 provides

$$\frac{200 W}{5 A} = 40 V$$

of the output voltage.

FIG. 13B illustrates an embodiment of a power harvesting system 1300 of the invention in a non-ideal condition. In this embodiment, the photovoltaic module 1329 is shaded, for example, only provides 100 W of power. In some embodiments, the DC power source (e.g., the photovoltaic module) provides less power due to overheating or abnormal operation, etc. Because the photovoltaic modules 1320-1328 are not shaded, the photovoltaic modules 1320-1328 provide 200 W of power. The DC to DC conversion module 1339 having the maximum power range maintains the photovoltaic conversion module with the maximum power point, thus, the maximum power is decreased at this moment.

At this time, the total energy received by the DC power source module string 1301 is 9×200 W+100 W=1900 watt. Because the input voltage of the DC to AC conversion module 1304 is maintained at 400 watt and the input voltage of the second DC to DC conversion module 1303 is decreased (for example decreased to 380 watt), the current I_{A} of the DC power source conversion module string 1301 is

$$\frac{1900 W}{380 V} = 5 volt$$

. It means that the current I_{A} flowing through each of the DC to DC conversion modules 1330-1339 must be 5 A in the DC power source conversion module string 1301. Therefore, the output voltage of the DC to DC conversion modules 1330-1339 corresponding to the photovoltaic modules 1320-1328, which are not shaded, is

$$\frac{200 W}{5 A} = 40 volt .$$

On the other hand, the output voltage of the DC to DC conversion module 1339 attaching to the shaded photovoltaic module 1329 is

$$\frac{100 W}{5 A} = 20 volt .$$

Because the DC to DC conversion modules 1330-1339 have the characteristic of the maximum power range, the photovoltaic modules 1320-1329 is easily tracked to the maximum power point by the DC to DC conversion modules.

In the other DC power source conversion module string 1302 of the power harvesting system 1300, all the photovoltaic modules are not shaded and the output power of the photovoltaic modules are 200 watt. Because the input voltage of the second DC to DC conversion module 1303 is reduced to 380 volt, the output current I_{B} of the DC power source conversion module string 1302 is

$$\frac{10 \times 200 W}{380 V} = 5.26 A .$$

As described in this example, no matter what the operating conditions (environmental conditions) are, the photovoltaic modules can be operated with the maximum power point. Therefore, even if one output of the DC power sources (photovoltaic modules) is decreased a lot, the output power of the system can be maintained to be quite high by the maximum power range of the DC to DC conversion module and the maximum power point tracking of the second DC to DC conversion module 1303, such that the photovoltaic module extracts energy with the maximum power point.

In some embodiments, a DC to AC conversion module of the maximum power point tracking can replace the second DC to DC conversion module 1303 and the DC to AC conversion module 1304, so the second DC to DC conversion module 1303 can be omitted. In another embodiment, the DC to AC conversion module 1304 can be omitted, but the DC output of the second DC to DC conversion module 1303 is directly fed into a charge/discharge circuit, for example, a battery.

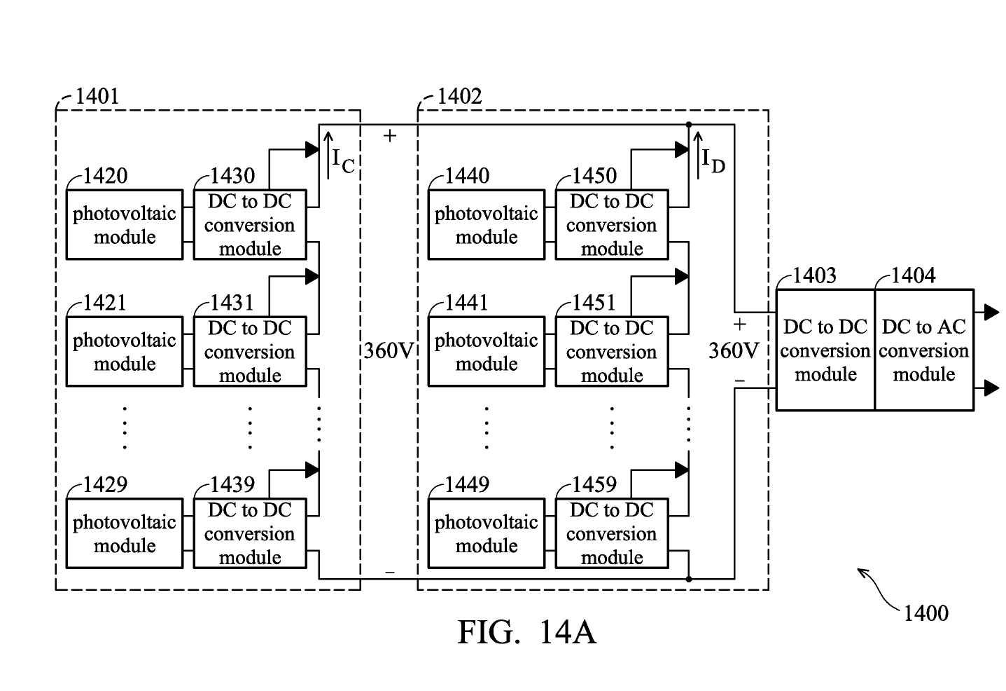

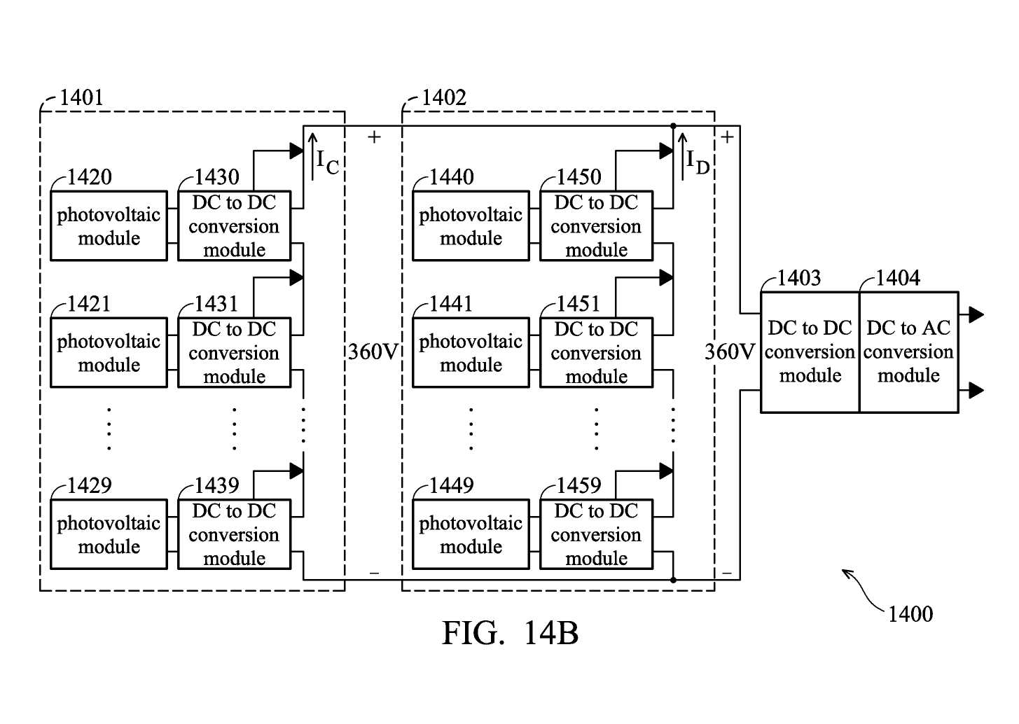

FIG. 14A illustrates another embodiment of a power harvesting system of the invention. As shown in FIG. 14A, the DC conversion modules 1430-1439 and 1450-1459 are not operated with the maximum voltage point. The output voltages of the DC power source conversion module strings 1401 and 1402 are lower than the corresponding output voltages shown in FIG. 13, but are not limited thereto. In this embodiment, the output voltages of the DC power source conversion module strings 1401 and 1402 are constant, for example, 360 volt. The second DC to DC conversion module 1403 increases the output voltages of the DC power source conversion module strings 1401 and 1402 (e.g., from 360 volt) to 380 volt or higher than 380 volt. Because each of the photovoltaic modules 1420-1429 and 1440-1449 provides 200 watt of power, the currents I_{C} and I_{D} flowing through each of the DC to DC conversion modules 1430-1439 and 1450-1459 have to be

$$\frac{200 W * 10}{360 V} = 5.55 A .$$

It means that the output voltage provided by each of the DC to DC conversion modules 1430-1439 and 1450-1459 is

$$\frac{200 W}{5.55 A} = 36 volt$$

in the ideal example.

FIG. 14B illustrates that the power harvesting system 1400, shown in FIG. 14A, is operated in a non-ideal condition. In the DC power source conversion module string 1402 of the power harvesting system 1400, all the photovoltaic modules 1440-1449 are not shaded and the output power is 200 watt. Because the input voltage of the second DC to DC conversion module 1403 is still 360 volt, the output current of the DC power source conversion module string 1402 is still

$$\frac{10 \times 200 W}{360 V} = 5.55 A ,$$

and the output voltage provided by the DC to DC conversion modules 1450-1459 is still

$$\frac{200 W}{5.55 A} = 36 volt .$$

However, in the embodiment, the photovoltaic module 1429 is shaded, for example, the photovoltaic module 1429 only provides 100 watt of power. Therefore, the output voltage of the DC to DC conversion module 1439 corresponding to the photovoltaic module 1429 is decreased, for example, down to 18 volt. Because the output voltage of the DC power source conversion module string 1401 is not varied and still 360 volt, the output voltages of the DC to DC conversion modules 1430-1439 are

$$\frac{360 V - 18 V}{9} = 38 volt$$

(in this embodiment, the output voltage of the DC to DC conversion modules 1430-1438 can be increased because the DC to DC conversion modules 1430-1438 are not operated with the maximum output voltage value). Therefore, all the DC to DC conversion modules 1430-1439 and 1450-1459 enable the power harvesting system 1400 to be operated with the maximum power point by the output characteristics of the maximum power range of the DC to DC conversion modules 1430-1439 and 1450-1459.

As described in the embodiment, no matter what the environmental conditions are, all photovoltaic modules 1420-1429 and 1440-1449 are operated with the maximum power point thereof. In this embodiment, in the maximum power range, the DC to DC conversion module is disposed in the junction box, but is not limited thereto. In some embodiments, when the DC to DC conversion module, coupled to the photovoltaic module, includes the boost converter, the photovoltaic module or the bypass diode of the junction box can be omitted. In some embodiments, the DC to AC conversion module having the maximum power point tracking can replace the second DC to DC conversion module 1403 and the DC to AC conversion module 1404, so the second DC to DC conversion module 1403 can be omitted. In other embodiments, the DC to AC conversion module 1404 can be omitted, but the DC output of the second DC to DC conversion module 1403 is directly fed into a charge/discharge circuit, for example, a battery.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A DC power source conversion module, comprising:
a DC power source module; and
a DC to DC conversion module, comprising:
a DC to DC converter, powered by the DC power source module to generate an output signal; and
a control module, sensing a responding signal of the DC to DC conversion module and controlling the DC to DC converter according to the sensed responding signal, such that the DC power source conversion module is operated at a predetermined output power, wherein the responding signal responds to the output signal of the DC to DC converter.

2. The DC power source conversion module as claimed in claim 1, wherein the predetermined output power is a maximum output power.

3. The DC power source conversion module as claimed in claim 2, wherein when the output signal of the DC to DC converter is within a predetermined range, the DC power source conversion module has the maximum output power.

4. The DC power source conversion module as claimed in claim 3, wherein the output signal is an output voltage.

5. The DC power source conversion module as claimed in claim 3, wherein the output signal is an output current.

6. The DC power source conversion module as claimed in claim 3, wherein the DC power source module is a photovoltaic module, a photovoltaic sub-module, a photovoltaic cell, a fuel cell or a vehicle battery.

7. The DC power source conversion module as claimed in claim 3, wherein the control module controls a duty cycle of the DC to DC converter according to the output signal.

8. The DC power source conversion module as claimed in claim 3, wherein the control module controls a work frequency of the DC to DC converter according to the output signal.

9. The DC power source conversion module as claimed in claim 3, wherein the DC to DC converter is a PWM converter.

10. The DC power source conversion module as claimed in claim 9, wherein the PWM converter is a buck converter, a boost converter, a buck-boost converter, a flyback converter or a forward converter.

11. The DC power source conversion module as claimed in claim 9, wherein the DC to DC converter is a resonant converter.

12. The DC power source conversion module as claimed in claim 9, wherein the resonant converter is a serial resonant converter.

13. The DC power source conversion module as claimed in claim 3, wherein the DC to DC converter is a buck converter, the output signal is the output voltage of the DC to DC converter and the control module controls the output voltage within a voltage range lower than a predetermined voltage, such that the DC to DC converter is operated with the maximum output power.

14. The DC power source conversion module as claimed in claim 3, wherein the DC to DC converter is a boost converter, the output signal is the output voltage of the DC to DC converter and the control module controls the output voltage within a voltage range higher than a predetermined voltage, such that the DC to DC converter is operated with the maximum output power.

15. The DC power source conversion module as claimed in claim 3, wherein the DC to DC converter is a buck-boost converter, the output signal is the output voltage of the DC to DC converter and the control module controls the output voltage within a voltage range, such that the DC to DC converter is operated with the maximum output power.

16. The DC power source conversion module as claimed in claim 3, wherein the DC to DC converter is a resonant converter, the output signal is the output current of the DC to DC converter and the control module controls the output current in a current range, such that the DC to DC converter is operated with the maximum output power.

17. The DC power source conversion module as claimed in claim 3, wherein the control module comprises:
a perturb module, providing a perturb signal;
a sampling module, sampling the responding signal to generate a first sampling signal and a second sampling signal;
an error amplifier module, generating an error amplifier signal according to the first sampling signal and the second sampling signal; and
a combination module, generating a control signal according to the perturb signal and the error amplifier signal, such that the DC to DC converter is operated with the maximum output power.

18. The DC power source conversion module as claimed in claim 17, wherein the combination module has a first input terminal coupled to the perturb signal and the error amplifier signal, a second input terminal coupled to a triangle wave signal and an output terminal outputting the control signal.

19. The DC power source conversion module as claimed in claim 18, wherein the error amplifier module is a scalar amplifier, an integral amplifier or a differential amplifier.

20. The DC power source conversion module as claimed in claim 17, wherein the switching frequency of the sampling module is lower than the switching frequency of the DC power source conversion module.

21. A method for a DC power source conversion module, comprising:
generating a perturb signal to perturb a control loop of a DC power source converter;
performing a positive sampling and a negative sampling on signals responding to an output voltage or an output current in the DC power source conversion module to generate a first sampling signal and a second sampling signal;
generating an error amplifier signal according the first sampling signal and the second sampling signal;
adding the error amplifier signal with the perturb signal to generate a control signal; and
controlling a work frequency or duty cycle of a DC to DC converter in the DC power source conversion module according to the control signal, such that the DC to DC converter is operated with a maximum output power.

22. The method as claimed in claim 21, wherein the step of perturbing the control loop comprises:
coupling a high level to the control loop of the DC to DC converter to perform the positive sampling; and
coupling a low level to the control loop of the DC to DC converter to perform the negative sampling.

23. The method as claimed in claim 21, wherein the positive sampling and the negative sampling are alternately performed.

24. The method as claimed in claim 21, wherein the frequencies of the positive sampling and the negative sampling are lower than the switching frequency of the DC power source conversion module.

25. A power harvesting system, comprising:
a photovoltaic module, comprising a plurality of photovoltaic sub-modules, wherein each photovoltaic sub-module is composed of a plurality of photovoltaic cells connected in series; and
a junction box, comprising a plurality of DC to DC conversion modules connected in series, wherein each the DC to DC conversion module comprises:
a DC to DC converter, powered by one of the photovoltaic sub-modules to generate an output voltage; and
a control module, sensing the output voltage and controlling the DC to DC converter according to the sensed output voltage, such that the DC to DC converter is operated in a predetermined power.

26. The power harvesting system as claimed in claim 25, wherein the predetermined output power is a maximum output power.

27. The power harvesting system as claimed in claim 26, wherein the DC to converter is a buck converter, a boost converter, a buck-boost converter, a flyback converter, a forward converter or a resonant converter.

28. The power harvesting system as claimed in claim 27, wherein each the DC to DC conversion module further comprises at least one bypass diode coupled between two input terminals of the DC to DC converter.

29. The power harvesting system as claimed in claim 27, wherein no bypass diode is coupled between two input terminals of each the DC to DC conversion module.

30. The power harvesting system as claimed in claim 27, wherein the control module controls a duty cycle or a work frequency of the DC to DC converter according to the output signal.

31. A power harvesting system, comprising:
a plurality of DC power source conversion module strings, having output terminals connected in series to provide a first output voltage and a output current, wherein each the DC power source conversion module string comprises a plurality of photovoltaic conversion modules connected in series and each photovoltaic conversion module comprises:
a photovoltaic module, composed of a plurality of photovoltaic sub-modules connected in series; and
a first DC to DC conversion module, comprising
a DC to DC converter, powered by the photovoltaic module to generate a second output voltage; and
a control module, sensing the second output voltage and controlling the DC to DC converter according the sensed second output voltage, such that the DC to DC converter is operated in a first predetermined output power; and
a DC to AC conversion module, coupled to the DC power source conversion module strings to generate a AC voltage.

32. The power harvesting system as claimed in claim 31, wherein the DC to converter is a buck converter, a boost converter, a buck-boost converter, a flyback converter, a forward converter or a resonant converter.

33. The power harvesting system as claimed in claim 31, wherein the first predetermined output power is a first maximum output power.

34. The power harvesting system as claimed in claim 31, wherein the control module controls a duty cycle or a work frequency of the DC to DC converter according to the second output voltage.

35. The power harvesting system as claimed in claim 31, further comprising:
a second DC to DC conversion module, having a maximum power point tracking to enable the power harvesting system to operated at a second maximum power point according to the first output voltage and the output current and generating a third output voltage, wherein the DC to AC conversion module converts the third output voltage to the AC voltage.

36. The power harvesting system as claimed in claim 31, wherein the first output voltage is a fixed voltage.

37. A junction box, comprising:
at least one DC to DC conversion module, comprising:
a DC to DC converter, powered by a DC power source module to generate an output signal; and
a control module, sensing a responding signal of the DC to DC conversion module and controlling the DC to DC converter according to the sensed responding signal, such that the DC to DC conversion module is operated in a predetermined power, wherein the responding signal responds to the output signal of the DC to DC converter.

38. The junction box as claimed in claim 37, comprising a plurality of DC to DC conversion modules, wherein the output terminals of the DC to DC conversion modules are connected in series.

39. The junction box as claimed in claim 38, wherein the DC power source module is a photovoltaic module and each DC to DC conversion module is powered by a photovoltaic sub-module of the photovoltaic module.

40. The junction box as claimed in claim 38, further comprising at least one bypass diode coupled between two input terminals of the DC to DC converter.

41. The junction box as claimed in claim 37, wherein the predetermined output power is a maximum output power.

42. The junction box as claimed in claim 37, wherein when the output signal of the DC to DC converter is within a predetermined range, the DC power conversion module has the maximum output power.

43. The junction box as claimed in claim 37, wherein the output signal is an output voltage or an output current.

44. The junction box as claimed in claim 41, wherein the DC power source module is a photovoltaic module, a photovoltaic sub-module, a photovoltaic cell, a fuel cell or a vehicle battery.

45. The junction box as claimed in claim 31, wherein the control module controls a duty cycle or a work frequency of the DC to DC converter according to the output signal.

46. The junction box as claimed in claim 37, wherein the DC to DC converter is a PWM converter.

47. The junction box as claimed in claim 46, wherein the PWM converter is a buck converter, a boost converter, a buck-boost converter, a flyback converter or a forward converter.

48. The junction box as claimed in claim 37, wherein the DC to DC converter is a resonant converter.

49. The junction box as claimed in claim 48, wherein the resonant converter is a serial resonant converter.

50. The junction box as claimed in claim 41, wherein the DC to DC converter is a buck converter, the output signal is the output voltage of the DC to DC converter and the control module controls the output voltage within a voltage range lower than a predetermined voltage, such that the DC to DC converter is operated with the maximum output power.

51. The junction box as claimed in claim 41, wherein the DC to DC converter is a boost converter, the output signal is the output voltage of the DC to DC converter and the control module controls the output voltage within a voltage range higher than a predetermined voltage, such that the DC to DC converter is operated with the maximum output power.

52. The junction box as claimed in claim 41, wherein the DC to DC converter is a buck-boost converter, the output signal is the output current of the DC to DC converter and the control module controls the output current in a voltage range, such that the DC to DC converter is operated with the maximum output power.

53. The junction box as claimed in claim 41, wherein the DC to DC converter is a resonant converter, the output signal is the output voltage of the DC to DC converter and the control module controls the output current in a current range, such that the DC to DC converter is operated with the maximum output power.
